(19) United States
(12) Patent Application Publication
(10) Pub. No.: US 2025/0268770 A1
(43) Pub. Date: Aug. 28, 2025

(54) PATIENT SUPPORT SURFACE HAVING A PNEUMATIC CONTROL ASSEMBLY

(71) Applicant: UMANO MEDICAL INC., L'Islet (CA)

(72) Inventors: Sylvain LACASSE, Québec (CA); Pascal POULIN, St-Lambert-de-Lauzon (CA); Thomas GREGOIRE, Sherbrook (CA); Pierre-Luc NADEAU, Levis (CA); Miguel FORTIN, Quebec (CA); Audrey LAINÉ, Levis (CA); Martin LAVOIE, Levis (CA); Steve BOLDUC, Beaumont (CA); Jérôme MARCOTTE, Levis (CA)

(21) Appl. No.: 19/063,416

(22) Filed: Feb. 26, 2025

Related U.S. Application Data
(60) Provisional application No. 63/558,342, filed on Feb. 27, 2024.

(51) Int. Cl. A61G 7/057; A61G 7/075

(52) U.S. Cl. CPC A61G 7/05776; A61G 7/0755

(57) ABSTRACT

A pneumatic control assembly for a patient support surface includes a first air supply device providing air at a high flow rate and a low pressure, and a second air supply device providing air at a low flow rate and a high pressure. At least one first valve is configured to be fluidly connected to at least one inflatable section of the patient support surface, the at least one first valve being selectively actuated to fluidly connect the first air supply device with a corresponding one of the at least one inflatable section. The at least one first valve is piloted by the second air supply device. Other aspects of the pneumatic control assembly are also disclosed.

### CROSS-REFERENCE

The present application claims priority from U.S. Provisional Patent Application No. 63/558,342, filed Feb. 27, 2024, the entirety of which is incorporated by reference herein.

### FIELD OF TECHNOLOGY

The present technology relates to patient support surfaces such as mattresses for patient support apparatuses such as hospital beds, and particularly to inflatable patient support surfaces.

### BACKGROUND

Inflatable mattresses are typically used on patient support apparatuses, namely hospital beds, to offer adaptable support for patients and different types of functions and therapies that are not easily achievable with a non-inflatable mattress. For instance, such inflatable mattresses may be available in more demanding environments such as in an intensive care unit (ICU) of a hospital. These inflatable mattresses usually include a pneumatic control assembly (sometimes referred to as a “pneumatic box” or “valve control box”) enclosed within the mattress to control the inflation of various inflatable bladders of the mattress. In some cases, the pneumatic control assembly may also be disposed outside of the mattress (e.g., in a separate control module disposed on the bed).

The design of the pneumatic control assembly poses various challenges. In particular, the pneumatic control assembly typically includes a multitude of valves to control air flow to the different inflatable bladders of the mattress in a relatively restricted volume defined by a housing of the pneumatic control assembly. The valves also usually produce a significant amount of heat during operation which is undesirable for the performance of the electric components of the control assembly and/or for heat management of the mattress itself. Furthermore, it is desirable to minimize the noise emitted by the pneumatic control assembly, namely by the valves thereof and/or by a fluid source (e.g., a blower).

In view of the foregoing, there is a need for a patient support surface that addresses at least some of these drawbacks.

### SUMMARY

It is an object of the present technology to ameliorate at least some of the inconveniences present in the prior art.

According to an aspect of the present technology, there is provided a pneumatic control assembly for a patient support surface, comprising: a first air supply device providing air at a high flow rate and a low pressure; a second air supply device providing air at a low flow rate and a high pressure; and at least one first valve configured to be fluidly connected to at least one inflatable section of the patient support surface, the at least one first valve being selectively actuated to fluidly connect the first air supply device with a corresponding one of the at least one inflatable section, the at least one first valve being piloted by the second air supply device.

In some embodiments, the first air supply device provides air at a first flow rate and a first pressure; the second air supply device provides air at a second flow rate and a second pressure; the first flow rate is greater than the second flow rate; and the second pressure is greater than the first pressure.

In some embodiments, the first air supply device is a blower and the second air supply device is a compressor.

In some embodiments, the first air supply device has a pressure capacity that is less than kPa.

In some embodiments, the second air supply device has a pressure capacity that is more than 50 kPa.

In some embodiments, each of the at least one first valve has a pilot port; the pneumatic control assembly further comprises at least one solenoid valve, the at least one solenoid valve being fluidly connected to the second air supply device and to the pilot port of the at least one first valve; and the at least one solenoid valve is selectively actuated to control air flow from the second air supply device to the pilot port of the at least one first valve to thereby actuate the at least one first valve.

In some embodiments, each of the at least one first valve is a diaphragm valve.

In some embodiments, the pneumatic control assembly further comprises a manifold comprising the at least one first valve, the manifold being in fluid communication with the first air supply device.

In some embodiments, the at least one inflatable section is at least one first inflatable section; the first air supply device is in selective fluid communication with the at least one first inflatable section via at least one first valve; the pneumatic control assembly further comprises: a third air supply device providing air at the high flow rate and the low pressure; and at least one second valve configured to be fluidly connected to at least one second inflatable section of the patient support surface, the at least one second valve being selectively actuated to fluidly connect the third air supply device with the at least one second inflatable section, the at least one second valve being piloted by the second air supply device.

In some embodiments, the third air supply device is a blower.

In some embodiments, the pneumatic control assembly further comprises: a reservoir that is fluidly connected to the second air supply device, the reservoir being filled by the second air supply device to contain pressurized air therein, the at least one first valve being selectively piloted by the reservoir.

In some embodiments, the pneumatic control assembly further comprises a housing enclosing the first air supply device, the second air supply device and the at least one first valve.

In some embodiments, a patient support surface for a patient support apparatus comprises: a plurality of inflatable sections; the pneumatic control assembly for controlling air flow to the inflatable sections; and a cover enclosing the inflatable sections and the pneumatic control assembly.

In some embodiments, the pneumatic control assembly is located near a foot end of the patient support surface.

In some embodiments, the inflatable sections include an inflatable foot section, the pneumatic control assembly being disposed underneath the inflatable foot section.

According to another aspect of the present technology, there is provided a pneumatic control assembly for a patient support surface, comprising: a first air supply device fluidly connected to a first inlet; at least one first valve fluidly connected to the first air supply device, the at least one first valve being configured to be fluidly connected to a respective one of at least one first inflatable section of the patient support surface; a second air supply device fluidly connected to a second inlet; and at least one second valve fluidly connected to the second air supply device, the at least one second valve being configured to be fluidly connected to a respective one of at least one second inflatable section of the patient support surface, the pneumatic control assembly being operable in: a direct feed mode wherein (i) the first air supply device pumps air from the first inlet to the at least one first valve, and/or (ii) the second air supply device pumps air from the second inlet to the at least one second valve; and a dual-stage compression mode wherein a given one of the first air supply device and the second air supply device pumps air from a corresponding one of the first inlet and the second inlet to an other one of the first air supply device and the second air supply device, and the other one of the first air supply device and the second air supply device pumps air received from the given one of the first air supply device and the second air supply device to a corresponding one of the at least one first valve and the at least one second valve.

In some embodiments, in the dual-stage compression mode: the given one of the first air supply device and the second air supply device is the first air supply device in response to a request to increase a pressure associated with the at least one second inflatable section; and the given one of the first air supply device and the second air supply device is the second air supply device in response to a request to increase a pressure associated with the at least one first inflatable section.

In some embodiments, the direct feed mode is engaged in response to a requested target pressure associated with the at least one first inflatable section or the at least second inflatable section is less than a threshold pressure; and the dual-stage compression mode is engaged in response to the requested target pressure associated with the at least one first inflatable section or the at least one second inflatable section is greater than the threshold pressure.

In some embodiments, the threshold pressure is less than a pressure capacity of each of the first and second air supply devices.

In some embodiments, each of the first air supply device and the second air supply device is a blower.

In some embodiments, each of the first air supply device and the second air supply device has a pressure capacity of between 4 and 6 kPa inclusively.

In some embodiments, the pneumatic control assembly further comprises: a first interconnection valve selectively fluidly connecting an outlet of the second air supply device with an inlet of the first air supply device; and a second interconnection valve selectively fluidly connecting an outlet of the first air supply device with an inlet of the second air supply device. In the dual-stage compression mode, one of the first interconnection valve and the second interconnection valve is opened, and an other one of the first interconnection valve and the second interconnection valve remains closed.

In some embodiments, the first and second interconnection valves are air piloted.

In some embodiments, the pneumatic control assembly further comprises: a first solenoid valve controlling air flow to a pilot port of the first interconnection valve; and a second solenoid valve controlling air flow to a pilot port of the second interconnection valve, the first and second solenoid valves being actuated to cause the first and second interconnection valves to be actuated respectively.

In some embodiments, the first and second interconnection valves are diaphragm valves.

In some embodiments, the pneumatic control assembly further comprises: a first manifold comprising the at least one first valve and the first interconnection valve; and a second manifold comprising the at least one second valve and the second interconnection valve.

In some embodiments, each of the first manifold and the second manifold comprises a main body defining at least in part a main valve chamber and an interconnection channel; the at least one first valve is disposed in the main valve chamber of the first manifold; the at least one second valve is disposed in the main valve chamber of the second manifold; the interconnection channel of the first manifold is fluidly connected to the main valve chamber of the second manifold; and the interconnection channel of the second manifold is fluidly connected to the main valve chamber of the first manifold.

In some embodiments, the main body of each of the first manifold and the second manifold defines at least in part a secondary valve chamber sealed off from the main valve chamber; the first interconnection valve is disposed in the secondary valve chamber of the first manifold; and the second interconnection valve is disposed in the secondary valve chamber of the second manifold.

In some embodiments, each of the first manifold and the second manifold: defines a first aperture opening into the interconnection channel; and a second aperture opening into the main valve chamber; the first aperture of the first manifold is fluidly connected to the second aperture of the second manifold; and the second aperture of the first manifold is fluidly connected to the first aperture of the first manifold.

In some embodiments, for each of the first manifold and the second manifold, the first and second apertures are located at a lateral end of the manifold; and the first manifold and the second manifold are oriented such that the first and second apertures of the first manifold are disposed near the first and second apertures of the second manifold.

In some embodiments, the first manifold and the second manifold are identical.

In some embodiments, the pneumatic control assembly is also operable in a deflate mode to depressurize the at least one first inflatable section or the at least one second inflatable section; in the deflate mode: (i) if the at least one first inflatable section is to be depressurized: the second interconnection valve is opened to fluidly connect the inlet of the second air supply device to the main valve chamber of the first manifold; a second inlet valve is closed to fluidly disconnect the second air supply device from the second inlet; the at least one first valve is opened to fluidly connect the at least one first inflatable section of the patient support surface with the main valve chamber of the first manifold; and the second air supply device is activated to draw air from the at least one first valve and thus from the at least one first inflatable section associated therewith; and (ii) if the at least one second inflatable section is to be depressurized: the first interconnection valve is opened to fluidly connect the inlet of the first air supply device to the main valve chamber of the second manifold; a first inlet valve is closed to fluidly disconnect the first air supply device from the first inlet; the at least one second valve is opened to fluidly connect the at least one second inflatable section of the patient support surface with the main valve chamber of the second manifold; and the first air supply device is activated to draw air from the at least one second valve and thus from the at least one second inflatable section associated therewith.

In some embodiments, the pneumatic control assembly further comprises a discharge valve fluidly connected to at least one of the first air supply device and the second air supply device; the discharge valve is configured to be fluidly connected to one of an internal space of the patient support surface and a component of the patient support surface other than an inflatable section; in the deflate mode: if the at least one first inflatable section is to be depressurized, the discharge valve is opened such that the second air supply device pumps air drawn from the at least one first valve through the discharge valve; and if the at least one second inflatable section is to be depressurized, the discharge valve is opened such that the second air supply device pumps air drawn from the at least one second valve through the discharge valve.

In some embodiments, the discharge valve is associated with a low air loss function of the patient support surface.

In some embodiments, in the deflate mode: if the at least one first inflatable section is to be depressurized, the first interconnection valve is opened and the first inlet valve is opened to fluidly communicate an outlet of the second air supply device to the first inlet valve in order to discharge air drawn from the at least one first valve through the first inlet valve; and if the at least one second inflatable section is to be depressurized, the second interconnection valve is opened and the second inlet valve is opened to fluidly communicate an outlet of the first air supply device to the second inlet valve in order to discharge air drawn from the at least one second valve through the second inlet valve.

In some embodiments, each of the first air supply device and the second air supply device provides air at a high flow rate and a low pressure; the pneumatic control assembly further comprises a third air supply device providing air at a low flow rate and a high pressure, the third air supply device being operable to pilot the at least one first valve and the at least one second valve in the direct feed mode and the dual-stage compression mode; the third air supply device is selectively fluidly connected to the at least one first valve and the at least one second valve; the pneumatic control assembly is also operable in a high pressure feed mode to pressurize the at least one first inflatable section or the at least one second inflatable section; in the high pressure feed mode, the third air supply device delivers air to the at least one first valve or the at least one second valve in order to pressurize the at least one first inflatable section or the at least one second inflatable section.

In some embodiments, a patient support surface comprises: a plurality of inflatable sections for supporting a patient; the pneumatic control assembly; and a cover enclosing the inflatable sections and the pneumatic control assembly.

According to another aspect of the present technology, there is provided a patient support surface comprising: a plurality of inflatable sections for supporting a patient; and a pneumatic control assembly for controlling a pressure within the inflatable sections of the patient support surface, the pneumatic control assembly comprising a first air supply device and a second air supply device for inflating and deflating the inflatable sections, the pneumatic control assembly being operable in a direct feed mode and a dual-stage compression mode to pressurize a given one of the inflatable sections of the patient support surface, wherein: in the direct feed mode, the first air supply device draws air external to the pneumatic control assembly and drives said air to the given one of the inflatable sections while bypassing the second air supply device, and in the dual-stage compression mode, the first air supply device draws air external to the pneumatic control assembly and drives said air to the second air supply device, the second air supply device then driving said air to the given one of the inflatable sections.

In some embodiments, the pneumatic control assembly further comprises a controller in communication with the first air supply device and the second air supply device; the controller operates the pneumatic control assembly in the direct feed mode or in the dual-stage compression mode to increase a current pressure of the given one of the inflatable sections to a target pressure, the controller operating in: (i) the direct feed mode in response to the target pressure being less than a threshold pressure; and (ii) the dual-stage compression mode in response to the target pressure being greater than the threshold pressure.

In some embodiments, the threshold pressure is less than a pressure capacity of each of the first and second air supplies.

In some embodiments, the first air supply device and the second air supply device have a same pressure capacity and flow rate.

According to another aspect of the present technology, there is provided a method for controlling a pneumatic control assembly of a patient support surface, the pneumatic control assembly comprising a first air supply device and a second air supply device, the method comprising: determining a target pressure for a given inflatable section of the patient support surface; comparing the target pressure with a current pressure of the given inflatable section; in response to the target pressure being greater than the current pressure and less than a threshold pressure, engaging a direct feed mode comprising: drawing air external to the pneumatic control assembly with the first air supply device; and driving air flow, by the first air supply device, to the given inflatable section while bypassing the second air supply device; in response to the target pressure being greater than the current pressure and greater than the threshold pressure, engaging a dual-stage compression mode comprising: drawing air external to the pneumatic control assembly with the first air supply device; driving air flow, by the first air supply device, to the second air supply device; and after driving air flow to the second air supply device, driving air flow, by the second air supply device, to the given inflatable section.

In some embodiments, the threshold pressure is less than a pressure capacity of each of the first and second air supply devices.

In some embodiments, the first air supply device and the second air supply device have a same pressure capacity and flow rate.

In some embodiments, the method further comprises: in response to the target pressure being less than the current pressure, engaging a deflate mode comprising: drawing air from the given inflatable section by the first air supply device; and driving air flow, by the first air supply device, outside of a pneumatic system of the patient support surface.

In some embodiments, the pneumatic control assembly further comprises a third air supply device that provides air at a greater pressure and a lower flow rate than the first and second air supply devices; the method further comprises, in response to the target pressure being greater than the current pressure and a required pressure adjustment being less than a threshold pressure adjustment, engaging a high pressure feed mode comprising: drawing air external to the pneumatic control assembly by the third air supply device; and driving air flow, by the third air supply device, to the given inflatable section.

According to another aspect of the present technology, there is provided a pneumatic control assembly for a patient support surface, comprising: a first air supply device providing air at a high flow rate and a low pressure; a second air supply device providing air at a low flow rate and a high pressure; and at least one valve configured to be fluidly connected to at least one inflatable section of the patient support surface, in a first operation mode, the first air supply device delivers air to the at least one valve in order to pressurize the at least one inflatable section, and in a second operation mode, the second air supply device delivers air to the at least one valve in order to pressurize the at least one inflatable section.

In some embodiments, the second operation mode is engaged in response to a pressure adjustment required at the at least one inflatable section being less than a threshold pressure adjustment.

In some embodiments, the first operation mode is engaged in response to the pressure adjustment at the at least one inflatable section being greater than the threshold pressure adjustment.

In some embodiments, each of the at least one valve has a pilot port; the second air supply device is fluidly connected to the pilot port of each of the at least one valve for actuation thereof; and in the first operation mode, the at least one valve is piloted by the second air supply device so that, in response to being actuated by the second air supply device, the at least one valve discharges air flow from the first air supply device to pressurize the at least one inflatable section.

In some embodiments, the pneumatic control assembly further comprises a reservoir containing pressurized air, the reservoir being in fluid communication with the pilot port of the at least one valve in order to actuate the at least one valve in the second operation mode.

In some embodiments, the reservoir is in selective fluid communication with the second air supply device, the reservoir being filled by the second air supply device.

In some embodiments, the pneumatic control assembly further comprises: at least one solenoid valve configured to selectively fluidly communicate the second air supply device with the at least one valve, in the first operation mode, air flow discharged by the second air supply device is routed to the at least one valve via the at least one solenoid valve, and in the second operation mode, air flow discharged by the second air supply device reaches the at least one valve by bypassing the at least one solenoid valve.

In some embodiments, the pneumatic control assembly further comprises a controller in communication with and controlling the first air supply device, the second air supply device and the at least one solenoid valve.

In some embodiments, the first air supply device is deactivated in the second operation mode.

In some embodiments, the first air supply device provides air at a first flow rate and a first pressure; the second air supply device provides air at a second flow rate and a second pressure; the first flow rate is greater than second flow rate; and the second pressure is greater than the first pressure.

In some embodiments, the first air supply device is a blower and the second air supply device is a compressor.

In some embodiments, the first air supply device has a pressure capacity that is less than kPa.

In some embodiments, the second air supply device has a pressure capacity that is more than 50 kPa.

In some embodiments, each of the at least one valve is a diaphragm valve.

In some embodiments, the at least one valve is a plurality of valves; and the pneumatic control assembly further comprises a manifold comprising the plurality of valves.

In some embodiments, the pneumatic control assembly further comprises a housing enclosing the first air supply device, the second air supply device and the at least one valve.

In some embodiments, a patient support surface for a patient support apparatus comprises: a plurality of inflatable sections for supporting a patient; the pneumatic control assembly for controlling air flow to the inflatable sections; and a cover enclosing the inflatable sections and the pneumatic control assembly.

In some embodiments, the pneumatic control assembly is located near a foot end of the patient support surface.

In some embodiments, the inflatable sections include an inflatable foot section, the pneumatic control assembly being disposed underneath the inflatable foot section.

According to another aspect of the present technology there is provided a pneumatic control assembly for a patient support surface, comprising: a first air supply device; a second air supply device; and at least one diaphragm valve for selectively fluidly connecting the first air supply device with at least one air-powered part of the patient support surface, each of the at least one diaphragm valve comprising: a pilot port in selective fluid communication with the second air supply device; an outlet aperture configured to be fluidly connected with the at least one air-powered part of the patient support surface; and a diaphragm that is selectively deformable from a first position to a second position in response to the pilot port being in fluid communication with the second air supply device, in the first position, the diaphragm being clear of the outlet aperture to allow air flow from the first air supply device therethrough, in the second position, the diaphragm blocking the outlet aperture to prevent air flow from the first air supply device therethrough.

In some embodiments, the diaphragm is biased to be in the first position.

In some embodiments, the at least one diaphragm valve is a plurality of diaphragm valves; the pneumatic control assembly further comprises at least one manifold, each of the at least one manifold comprising: a main body defining at least in part an internal chamber, the internal chamber being in fluid communication with the first air supply device; and the plurality of diaphragm valves contained at least in part within the internal chamber.

In some embodiments, the at least one manifold comprises a first manifold and a second manifold, the second manifold being identical to the first manifold.

In some embodiments, the first manifold is oriented at a 180° offset relative to the second manifold.

In some embodiments, the at least one manifold comprises a first manifold and a second manifold; and the first manifold is in selective fluid communication with the second manifold.

According to another aspect of the present technology, there is provided a valve module for use in a pneumatic control assembly of a patient support surface, the valve module comprising: a first member comprising a pilot port; a diaphragm that is selectively deformable; and a second member coupled to the first member and retaining a peripheral portion of the diaphragm therebetween.

In some embodiments, the second member has a stepped peripheral portion.

In some embodiments, the valve module is generally disc-shaped.

In some embodiments, a chamber is formed between the first member and the diaphragm that is pressurized via the pilot port.

According to another aspect of the present technology, there is provided an air supply unit for a patient support surface, comprising: an enclosure; an air supply device contained within the enclosure; and an attenuating filler extending between an outer surface of the air supply device and an inner surface of the enclosure to fix the air supply device in place within the enclosure.

In some embodiments, the attenuating filler comprises a plurality of filler members.

In some embodiments, the plurality of filler members includes an upper filler member overlying the air supply device and a lower filler member underlying the air supply device.

In some embodiments, the attenuating filler defines at least one recess that is a negative of a shape of the air supply device.

In some embodiments, the enclosure has an enclosure inlet and an enclosure outlet; the air supply device has a device inlet and a device outlet; and the attenuating filler defines at least one channel for fluidly connecting the enclosure inlet to the device inlet and at least one channel for fluidly connecting the enclosure outlet to the device outlet.

In some embodiments, the air supply unit further comprises a flexible sleeve connecting the device outlet to the enclosure outlet.

In some embodiments, the flexible sleeve is made of fabric.

In some embodiments, the air supply device is a blower.

In some embodiments, a pneumatic control assembly for the patient support surface comprises: a housing; the air supply unit enclosed within the housing, a chamber being defined between an inner surface of the enclosure of the air supply unit and the housing of the pneumatic control assembly, the air supply device being disposed within the chamber, the air supply device being detached from the housing of the pneumatic control assembly.

Embodiments of the present technology each have at least one of the above-mentioned objects and/or aspects, but do not necessarily have all of them. It should be understood that some aspects of the present technology that have resulted from attempting to attain the above-mentioned objects may not satisfy these objects and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view, taken from a top, left side, of a mattress according to an embodiment of the present technology, shown with a patient lying on the mattress;

FIG. 2 is a perspective view, taken from a top, right side, of a patient support apparatus configured to support the mattress of FIG. 1;

FIG. 3 is a right side elevation view of the patient support apparatus of FIG. 2, showing the patient support apparatus in a chair egress position;

FIG. 4 is a perspective view, taken from a top, left side of the mattress of FIG. 1, with a top portion of a cover of the mattress removed to expose the internal components of the mattress;

FIG. 5 is a top plan view of the mattress of FIG. 4;

FIG. 6A is a cross-sectional view of the mattress taken along line 6A-6A in FIG. 5;

FIG. 6B is a cross-sectional view of the mattress taken along the same plane as FIG. 6A, showing inflatable lateral extensions of the mattress in a collapsed state;

FIG. 7 is a perspective view, taken from atop, right side of a pneumatic control assembly of the mattress of FIG. 4, with a cover portion of a housing of the pneumatic control assembly being shown removed from a base portion of the housing;

FIG. 8 is a top plan view of part of the pneumatic control assembly of FIG. 7, including the base portion of the housing and internal components received thereby, shown with blower housings removed to expose respective blowers disposed therein;

FIG. 9 is a bottom plan view of the part of the pneumatic control assembly of FIG. 7;

FIG. 10 is a flow diagram of a method for controlling the pneumatic control assembly in accordance with an embodiment of the present technology;

FIG. 11 is a schematic diagram of a pneumatic system of the pneumatic control assembly of FIG. 7;

FIG. 12 is a top perspective view of a manifold of the pneumatic control assembly of FIG. 7;

FIG. 13 is a bottom perspective view of the manifold of FIG. 12;

FIG. 14 is an exploded view of the manifold of FIG. 12;

FIG. 15 is a cross-sectional view taken along line 15-15 shown in FIG. 12;

FIG. 16 is a perspective view, taken from a top, left side, of a main body of the manifold of FIG. 12;

FIG. 17 is a perspective view, taken from bottom, left side, of the main body of FIG. 16;

FIG. 18 is a perspective view, taken from a top, left side, of an outlet connector of the manifold of FIG. 12;

FIG. 19 is a top plan view of the outlet connector of FIG. 18;

FIG. 20 is a top perspective view of a valve module of the manifold of FIG. 12;

FIG. 21 is a cross-sectional view of the valve module of FIG. 20 taken along line 21-21 in FIG. 20;

FIG. 22 is an exploded view of the valve module of FIG. 20;

FIG. 23 is a voltage to time graph representing an applied voltage of a compressor of the pneumatic control assembly according to one embodiment;

FIG. 24 is a perspective view, taken from top left side, of a valve module according to another embodiment;

FIG. 25 is a cross-sectional view of the valve module of FIG. 24 taken along line 25-25 in FIG. 24;

FIG. 26 is an exploded view of the valve module of FIG. 24;

FIG. 27 is a schematic diagram of an alternative embodiment of the pneumatic system of the pneumatic control assembly;

FIG. 28 is a top perspective view of two manifolds of the pneumatic control assembly according to an alternative embodiment;

FIG. 29 is atop perspective view of an air supply unit of the pneumatic control assembly;

FIG. 30 is a top plan view of the air supply unit of FIG. 29;

FIG. 31 is an exploded view of the air supply unit of FIG. 29; and

FIG. 32 is a cross-sectional view of the air supply unit of FIG. 29 take along line 32-32 of FIG. 30.

### DETAILED DESCRIPTION

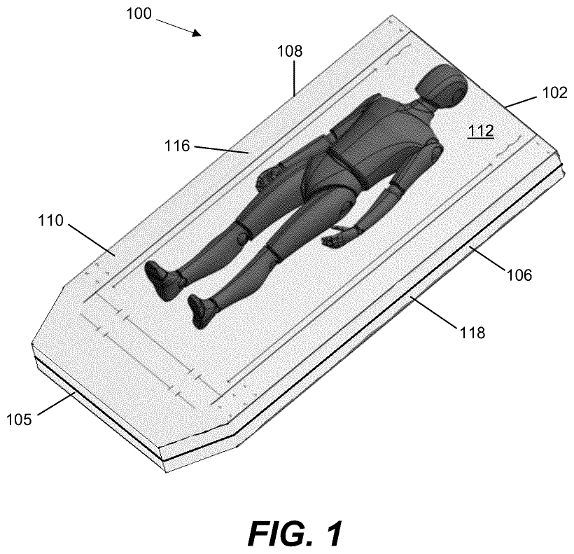

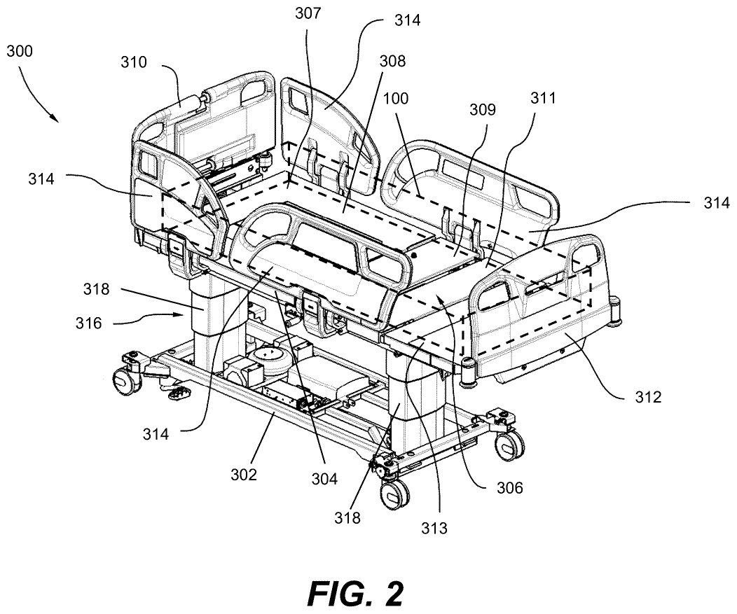

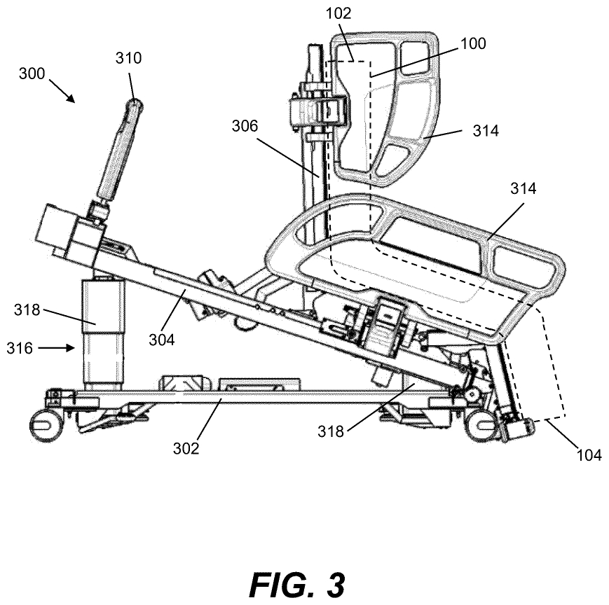

A mattress 100 in accordance with an embodiment of the present technology is illustrated in FIG. 1. The mattress 100 may be used in a medical setting to comfortably support a patient thereon. The mattress 100 may alternatively be referred to as a “patient support surface”. As shown in FIGS. 2 and 3, the mattress 100 can be used in conjunction with a patient support apparatus 300 such as a hospital bed. As will be explained in greater detail below, the mattress 100 is constituted in part by multiple inflatable bladders that are selectively pressurized to varying degrees to provide different features to the mattress 100, such as different treatments, movement facilitation and/or compatibility with certain functions of the patient support apparatus 300 amongst others.

With reference to FIGS. 2 and 3, in this embodiment, the patient support apparatus 300 is a hospital bed intended for use in an intensive care unit (ICU). As such, the bed 300 has advanced functions that are typically not available in an ordinary hospital bed. Nevertheless, it is contemplated that, in other embodiments, the bed 300 may be an ordinary hospital bed that does not have all the advanced functions expected from an ICU bed. The bed 300 has a base 302, an upper frame 304 operatively connected to the base 302, and a deck 306 connected to the upper frame 304. The deck 306 includes multiple deck sections 307, 309, 311, 313 that are movable relative to each other and define a surface 308 of the deck 306 on which, in use, the mattress 100 is supported. The bed 300 also has a headboard 310 at a head end thereof and a footboard 312 at a foot end thereof. A plurality of siderails 314 is also provided on which one or more user interfaces (e.g., a graphic display such as a touch screen) may be provided to allow a user (e.g., a medical practitioner) to control certain functions of the bed 300 and/or the mattress 100 as well as to access information relating to the bed 300, the mattress 100 and/or the patient.

An elevation system 316 operatively connects the upper frame 304 to the base 302 and allows adjustment of the height of the upper frame 304. In this embodiment, the elevation system 316 includes two lift columns 318 that are longitudinally spaced from each other. Each lift column 318 includes an actuator (not shown) that is operable to adjust the height of the lift column 318. The height of the lift columns 318 can be adjusted separately such that the head end and foot end of the upper frame 104 is set at different heights. As such, the bed 300 can be set to different positions including a flat horizontal position (shown in FIG. 2), also known as the bed position, a Trendelenburg position, a reverse Trendelenburg position, a cardiac chair position, and a chair egress position (shown in FIG. 3), amongst others.

The bed 300 also has an adjustable length, by selectively extending and retracting a foot deck section 313 of the deck 306, and an adjustable width by selectively extending and retracting slidable panels from each side of one of the deck sections 307, 309, 311, 313 of the deck 306. Notably, in this embodiment, the bed 300 is designed to be used by bariatric patients which typically will need a bed with a larger width due to their size.

A more complete description of the construction and features of the bed 300 can be found in International Patent Application Publication No. 2023/002370A1, published on Jan. 26, 2023, the entirety of which is incorporated by reference herein.

The bed 300 may be configured differently in other embodiments. For instance, in some embodiments, the elevation system 316 may instead have a head end lift assembly and a foot end lift assembly, each having a generally inverted-Y shape and including a lift leg which has a lower end that is slidably connected to the base 302. In such an example, the head end and foot end lift assemblies are selectively collapsible to adjust the height of the upper frame 304.

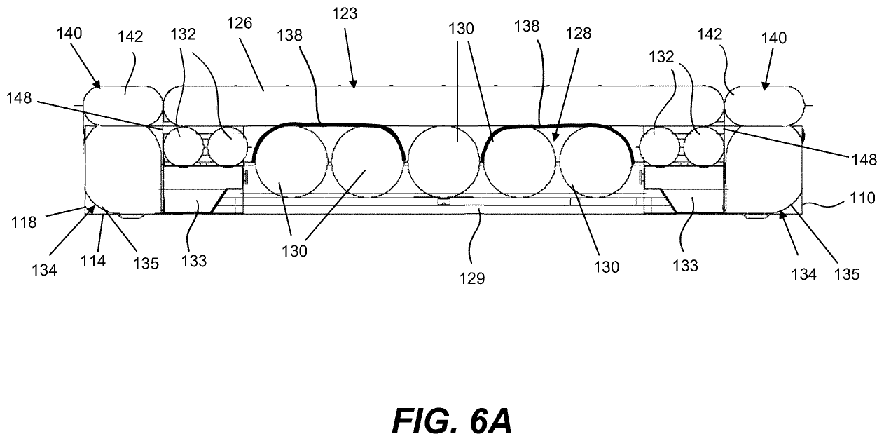

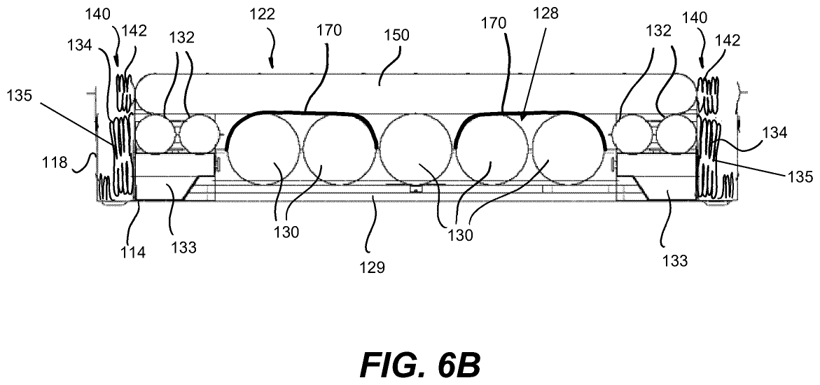

The mattress 100 will now be described with reference to FIGS. 1 and 4 to 6A. As shown in FIG. 1, the mattress 100 extends longitudinally from a head end 102 to a foot end 105 and extends laterally from a left end 106 to a right end 108. A length of the mattress 100 is defined between the head end 102 and the foot end 105, while a width of the mattress 100 is defined between the left and right ends 106, 108. The mattress 100 has a cover 110 that defines the exterior surfaces of the mattress 100. Notably, the cover 110 has a top surface 112 on which the patient is supported, and a bottom surface 114 (FIG. 6A) opposite the top surface 112. A thickness of the mattress 100 is defined between the top and bottom surfaces 112, 114. In this embodiment, the top surface 112 is permeable to moisture and impermeable to air. In other embodiments, the top surface 112 may be permeable to air and impermeable to moisture. In use, the bottom surface 114 is in contact with the deck 306 of the bed 300. In this embodiment, the cover 110 has a top portion 116 and a bottom portion 118 that are held together via a fastening system to contain the internal components of the mattress 100 that are disposed between the top and bottom surfaces 112, 114. In this example, the fastening system is a slide fastener (i.e., a zipper) that holds at least part of the top and bottom portions 116, 118 of the cover 110 together. Other types of fastening systems are also contemplated.

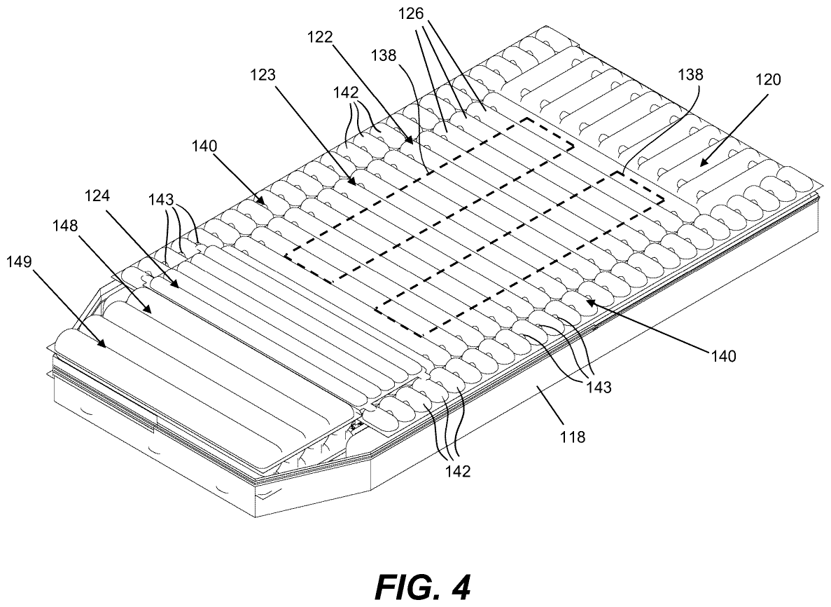

Some of the internal components of the mattress 100 are shown in greater detail in FIGS. 4 to 6B. As can be seen, the mattress 100 has a multitude of air-powered sections, including a plurality of inflatable sections that are selectively inflated and deflated to varying degrees in accordance with a desired configuration and/or function of the mattress 100. In particular, with reference to FIG. 4, the mattress 100 has an inflatable head section 120 for supporting the patient's head, an inflatable back section 122 for supporting the patient's torso, an inflatable seat section 123 for supporting the patient's upper legs, and an inflatable foot section 124 for supporting the patient's calves and feet. In this embodiment, the inflatable foot section 124 partly overlaps the inflatable seat section 123. Each of the inflatable sections 120, 122, 123, 124 includes a plurality of inflatable bladders 126 that can expand and contract in accordance with the degree of inflation thereof.

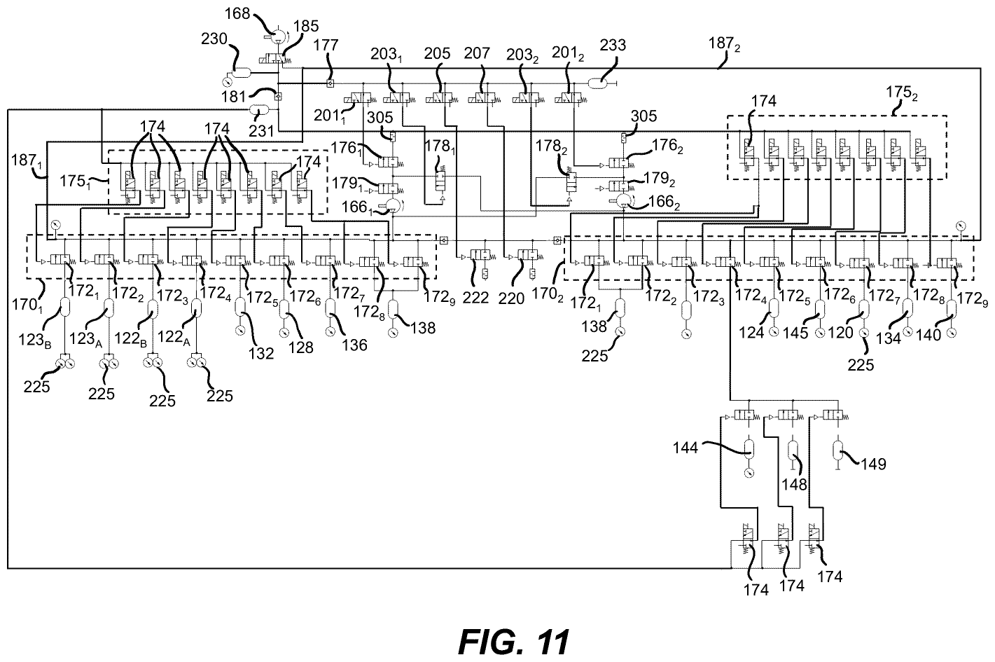

With reference to FIG. 11 which illustrates an example of a pneumatic diagram of the mattress 100, the inflatable back section 122 includes a first inflatable back section 122A and a second inflatable back section 122B which can be pressurized separately to provide an alternating pressure therapy function. In particular, the inflatable bladders 126 of the inflatable back sections 122A, 122B are arranged alternatingly consecutively to each other such that each inflatable bladder 126 of the first section 122A is disposed next to an inflatable bladder 126 of the second section 122B. Similarly, the inflatable seat section 123 is divided into a first inflatable seat section 123A and a second inflatable seat section 123B which can be pressurized separately to provide an alternating pressure therapy function.

The inflatable bladders 126 can be made in any suitable way, including by welding two sheets (e.g., an upper sheet and a lower sheet) of material along predetermined locations to form the bladders 126 and communication channels between the bladders 126 such that bladders 126 that are part of a common pneumatic zone (i.e., a given inflatable section) are fluidly connected to each other via the communication channels. In this embodiment, the inflatable bladders 126 are elongated and generally extend either longitudinally or laterally. For instance, the inflatable bladders 126 of the inflatable back section 122, inflatable seat section 123 and the inflatable foot section 124 extend laterally while the inflatable bladders 126 of the inflatable head section 120 extend longitudinally. The bladders 126 of the sections 120, 122, 123, 124 may be oriented differently in other embodiments.

For each given inflatable section 120, 122A, 122B, 123A, 123B, 124, the inflatable bladders 126 thereof are fluidly connected to one another so that the inflatable bladders 126 of the given inflatable section are inflated and deflated together. As such, the inflatable sections 120, 122A, 122B, 123A, 123B, 124 constitute separate pneumatic control zones.

Together, the inflatable sections 120, 122, 123, 124 form a comfort layer of the mattress 100. The pressure of the inflatable bladders 126 of the comfort layer is generally regulated to provide comfort to the patient as the inflatable bladders 126 of the comfort layer are the support components that are closest to the patient when the patient lies on the mattress 100.

In this embodiment, as shown schematically in FIG. 11, the mattress 100 also includes a first foot extension section 148 and a second foot extension section 149 that are selectively inflated to extend a length of the mattress 100. Notably, when the foot extension sections 148, 149 are both inflated, the length of the mattress 100 is at its maximum (e.g., 88 inches), and when the foot extension sections 148, 149 are both deflated, the length of the mattress 100 is at its minimum (e.g., 80 inches). The foot extension sections 148, 149 are separate pneumatic control zones such that it is also possible to only inflate the first foot extension section 148 and keep the second foot extension section 149 deflated, in which case the mattress 100 has an intermediate length (e.g., 84 inches) between the maximum and minimum lengths.

The mattress 100 also has a support layer disposed underneath the comfort layer to provide more rigidity to the mattress 100. The comfort layer is generally softer than the support layer. With reference to FIG. 6A, the support layer includes a seat support section 128 disposed underneath the inflatable seat section 123. In this embodiment, the seat support section 128 is also inflatable and includes a plurality of support bladders 130 that are inflated and deflated according to a desired rigidity of the mattress 100. That is, the pressure within the support bladders 130 is regulated to provide adequate rigidity to the mattress 100 as may be necessary. In this embodiment, the support bladders 130 are elongated and extend longitudinally. The support bladders 130 are in fluid communication with each other such that they form a common pneumatic control zone.

With reference to FIG. 11, the mattress 100 also has a back support section 136 and a foot support section 144 which are disposed underneath the inflatable back section 122 and the inflatable foot section 124 respectively. The back and foot support sections 136, 144 are configured similarly to the seat support section 128 and have similar functions to the seat support section 128 described above but with respect to the inflatable back section 122 and the inflatable foot section 124 respectively.

It is contemplated that the support sections of the mattress 100 could be configured differently in other embodiments. For instance, in some embodiments, the support sections could instead include one or more foam members rather than including inflatable bladders.

With reference to FIGS. 4, 6A and 6B, in this embodiment, left and right turning bladders 138 (schematically illustrated in FIG. 4) are provided to turn a patient toward either lateral side of the mattress 100. More specifically, the left and right turning bladders 138 are selectively inflated to turn the patient toward the right and left sides of the mattress 100 respectively. As shown in FIGS. 6A and 6B, in this embodiment, the left and right turning bladders 138 are disposed in part between the seat support section 128 and the inflatable seat section 123. In other words, the turning bladders 138 are disposed above the seat support section 128 and below the inflatable seat section 123. The turning bladders 138 also extend between the back support section 136 and the inflatable back section 122. The left and right turning bladders 138 are disposed on opposite sides of a longitudinal centerplane of the mattress 100 (i.e., a vertical plane bisecting the width of the mattress 100) and, as shown in FIG. 4, each of the left and right turning bladders 138 extends along a torso portion of the mattress 100 (i.e., a portion of the mattress 100 that will generally be aligned with the torso of the patient) as well as part of a seat portion of the mattress 100.

As shown in FIGS. 6A and 6B, the mattress 100 also has a structural foam layer 129 disposed underneath the seat support section 128 and the back support section 136. The structural foam layer 129 could be omitted in some embodiments.

With continued reference to FIG. 6A, in this embodiment, the mattress 100 also has outer lateral support bladders 132 disposed laterally outwardly from the support bladders 130. Each of the outer lateral support bladders 132 sits underneath an outer lateral portion of the inflatable back section 122. The outer lateral support bladders 132 are disposed atop a respective foam support block 133 that extends longitudinally. The foam support blocks 133 may house some components such as pneumatic tubing for routing air to and from some of the inflatable sections of the mattress 100. The foam support blocks 133 may also provide additional rigidity to the mattress 100. As can be seen, when inflated at their operating pressure, the outer lateral support bladders 132 have a cross-sectional profile having a height that is smaller than a height of the support bladders 130 when the latter are at their operating pressure.

It is contemplated that the outer lateral support bladders 132 could be omitted in other embodiments. For instance, in some embodiments, the outer lateral support bladders 132 could instead be replaced by additional support bladders 130, and the foam support blocks 133 could be omitted.

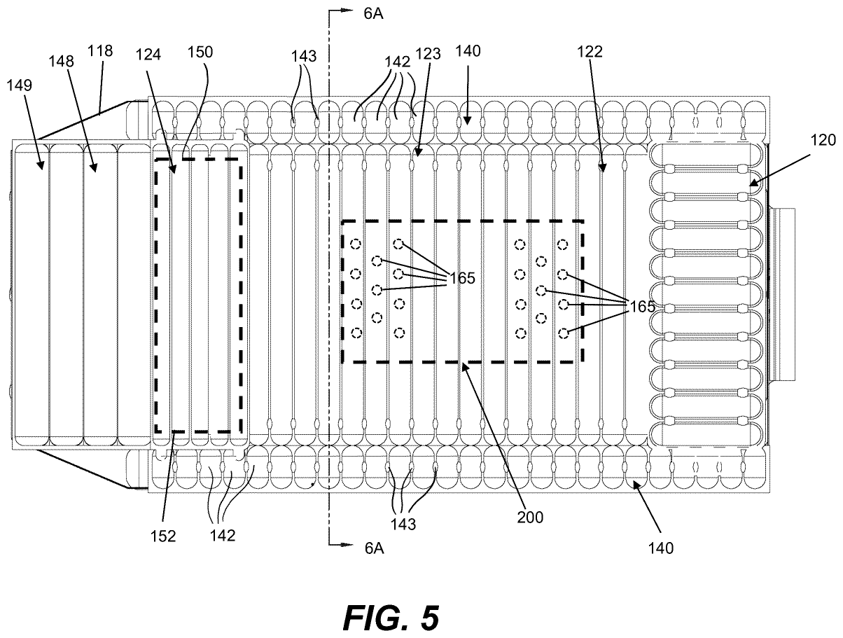

As shown in FIGS. 4 and 5, in this embodiment, to each side of the inflatable back section 122 and the inflatable seat section 123, there is disposed a respective inflatable lateral extension 140 that spans a majority of the length of the mattress 100. The lateral extensions 140 are selectively inflated to adjust a width of the mattress 100. Notably, the lateral extensions 140 can be deflated such that respective bladders of the lateral extensions 140 collapse (as shown in FIG. 6B), thereby reducing the width of the mattress 100, and conversely the lateral extensions 140 can be inflated (as shown in FIGS. 4 to 6A) to increase the width of the mattress 100 to approximately a 45-inch width. This may be useful for example to accommodate bariatric patients. Moreover, this feature may be used in conjunction with a width extending function of the bed 300. In some embodiments, the lateral extensions 140 may be omitted (i.e., the width of the mattress 100 may not be adjustable). Each lateral extension 140 has a plurality of lateral extension bladders 142 that are disposed side-by-side in the longitudinal direction of the mattress 100. For each lateral extension 140, the lateral extension bladders 142 thereof are in fluid communication with each other via communication channels 143 defined between consecutive ones of the lateral extension bladders 142.

In some embodiments, the lateral extension 140 may be a first lateral extension, and a second lateral extension may be provided laterally outwardly of the first lateral extension. In such cases, the first lateral extension may be inflated to achieve a first extended width of the mattress 100, and the second lateral extension may be inflated to achieve a second extended with of the mattress 100 greater than the first extended width.

As shown in FIG. 6A, the mattress 100 also has inflatable lateral support sections 134 disposed underneath respective ones of the lateral extensions 140. Each lateral support section 134 includes a plurality of lateral support bladders 135 (only one of which is shown in FIG. 6A) that are disposed side-by-side in the longitudinal direction of the mattress 100. The lateral support sections 134 provide additional rigidity to the mattress 100 at the lateral outer portions thereof when the lateral extensions 140 are deployed. To that end, the lateral support bladders 135 are selectively inflatable together with the lateral extension bladders 142 of the lateral extensions 140. In other words, the lateral support bladders 135 are inflated (as shown in FIG. 6A) together with the lateral extension bladders 142, and are deflated (as shown in FIG. 6B) together with the lateral extension bladders 142. When the lateral extensions 140 and the lateral support sections 134 are deployed, a pressure to which the lateral support bladders 135 are pressurized is greater than the pressure within the lateral extension bladders 142 in order to provide a rigid support below the lateral extension bladders 142. In some cases, the pressure in the lateral extension bladders 142 may be adjusted, namely reduced, to decrease a thickness of the mattress 100 at the lateral outer side thereof and thereby facilitate a patient exiting the bed from the side, while a pressure within the lateral support bladders 135 remains constant to provide a rigid support underneath the lateral extension bladders 142. It is contemplated that, in some embodiments, the lateral support bladders 135 could be omitted (e.g., the lateral extension bladders 142 could instead extend vertically to the level of the support bladders 130).

In this embodiment, the left and right lateral extensions 140 are in fluid communication with each other via a fluid connection (e.g., pneumatic tubing). As such, in this example, the left and right lateral extensions 140 are deployed and collapsed simultaneously. In other words, the left and right lateral extensions 140 form a common pneumatic zone. It is contemplated that, in other embodiments, the left and right lateral extensions 140 could be fluidly independent from each other (i.e., they could be independent pneumatic zones) such that the left and right lateral extensions 140 could be deployed or collapsed independently from each other.

In this embodiment, the mattress 100 also has a dorsal push bladder 145 (shown schematically in FIG. 11) configured to be selectively inflated to help the patient out of the mattress 100. More specifically, the dorsal push bladder 145 is inflated in response to the bed 300 moving to its chair egress position (FIG. 3) in order to assist the patient to move forward when they are exiting the bed 300 from the chair egress position. The dorsal push bladder 145 may be disposed underneath the back support section 136 and extends along a torso portion of the mattress 100 (i.e., the part of the mattress 100 intended to be aligned with a torso of the patient). The dorsal push bladder 145 could be omitted in other embodiments.

Furthermore, as illustrated in hidden lines in FIG. 5, in this embodiment, the mattress 100 also has a microclimate management layer 200 configured to diffuse air towards the top surface 112 of the mattress 100. This may help improve patient comfort, namely by keeping the patient cool and dry or by eliminating humidity that has penetrated the mattress 100. The microclimate management layer 200 is disposed above the inflatable back section 122. In other words, the microclimate management layer 200 is disposed between the inflatable back section 122 and the top surface 112. The microclimate management layer 200 defines in part a pocket configured to receive air therein. The pocket may define openings 165 through which air flows above the comfort layer of the mattress 100. The microclimate management layer 200 thus provides a low air loss function of the mattress 100. The microclimate management layer 200 may be omitted in other embodiments.

A pneumatic control assembly 150, illustrated in hidden lines in FIG. 5, is provided to distribute air to the various air-powered parts of the mattress 100, including the various inflatable sections and the microclimate management layer 200 described above. The pneumatic control assembly 150 is disposed along a foot portion of the mattress 100, namely underneath the foot support section 144 and the inflatable foot section 124. It is contemplated that, in other embodiments, the pneumatic control assembly 150 could be located elsewhere along the mattress 100 (e.g., along the head portion of the mattress 100).

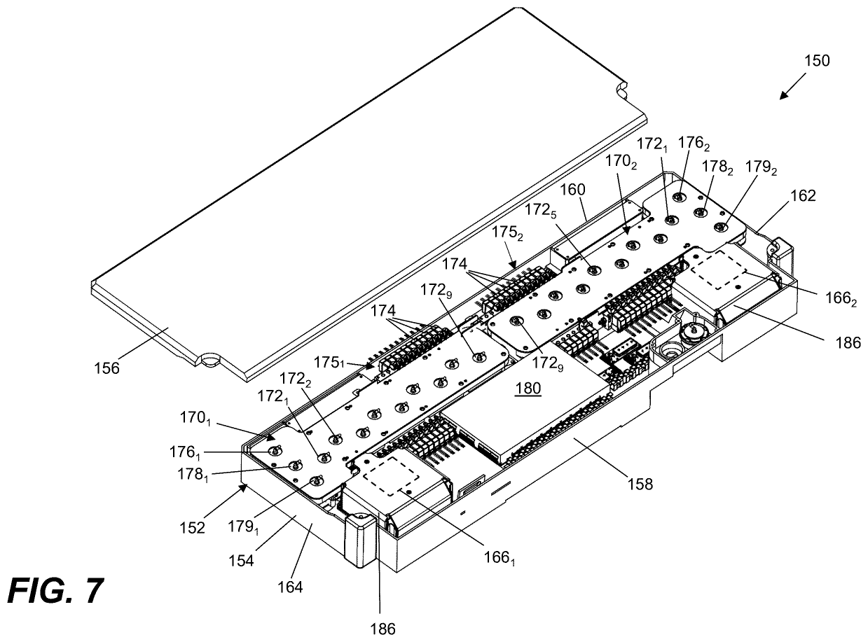

As shown in FIG. 7, the pneumatic control assembly 150 has an external housing 152 for enclosing the internal components of the pneumatic control assembly 150. The housing 152 has a base portion 154 and a cover portion 156 that is removably connected to the base portion 154. The housing 152 has a foot end 158 and a head end 160 which are longitudinally spaced from each other, and a left end 162 and a right end 164 which are laterally spaced from each other. The housing 152 has a larger width, defined between left and right ends 162, 164, than a length, defined between foot and head ends 158, 160. Bumpers (not shown) may be provided at the left and right ends 162, 164 of the housing 152 to protect the pneumatic control assembly 150 from impacts. As will be described in more detail below, the housing 152 defines internal channels that communicate different parts of the pneumatic control assembly 150 with each other.

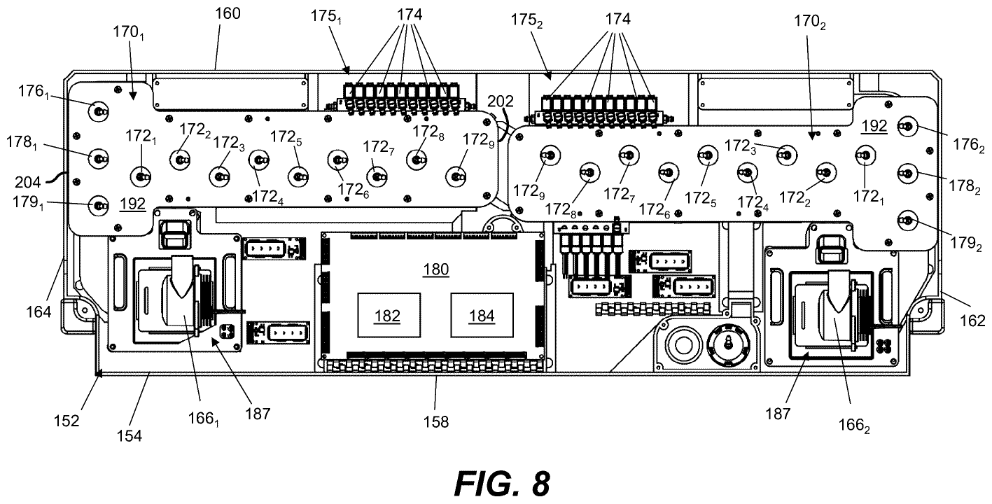

The pneumatic control assembly 150 has an air supply device that pressurizes air for distribution to the different air-powered parts of the mattress 100. More particularly, as shown in FIGS. 8 and 11, in this embodiment, the pneumatic control assembly 150 has a plurality of air supply devices including two blowers 166₁, 166₂ that are in selective communication with different parts of the mattress 100 to feed air thereto or aspirate the air contained thereby. Blowers provide a high flow rate of air which can be useful for rapidly inflating the different bladders of the mattress 100, thereby reducing the time necessary for the mattress 100 to reach adequate pressure levels (e.g., at initialization of the mattress 100 or to accommodate a different position of the bed 300). For instance, the blowers 166₁, 166₂ have a flow rate that is greater than 100 Lpm. In this example, the blowers 166₁, 166₂ have a flow rate of approximately 500 Lpm. However, while blowers can supply large volumes of air quickly, their capacity to pressurize the air is relatively limited. For instance, the blowers 166₁, 166₂ may have a pressure capacity that is less than 15 kPa. In other words, the blowers 166₁ may pressurize the air between 0 and 15 kPa. More specifically, in this example, the blowers 166₁, 166₂ each have a pressure capacity of approximately 5.4 kPa (i.e., approximately 42 mm Hg). The blowers 166₁, 166₂ thus supply air at a high flow rate and at a low pressure. As will be described in greater detail below, in this embodiment, the pneumatic control assembly 150 can selectively operate in a dual-stage compression mode whereby air is made to be pressurized consecutively by each blower 166₁, 166₂ before distributing air to one or more of the air-powered parts of the mattress 100. This may allow the air to reach a greater pressure than would be possible if a single blower were to supply that air.

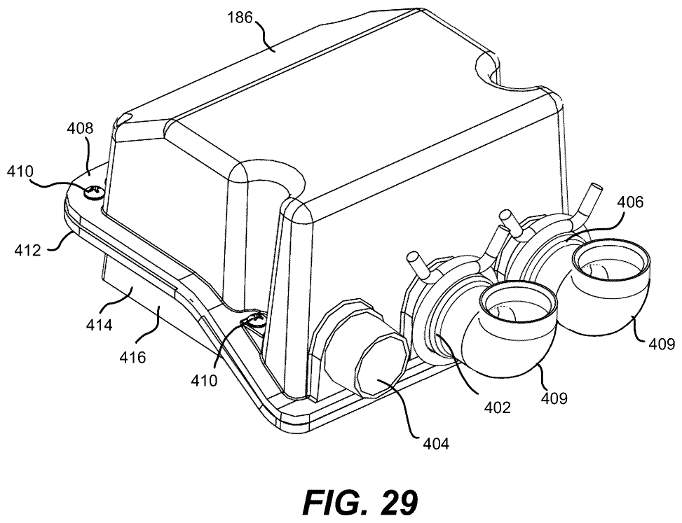

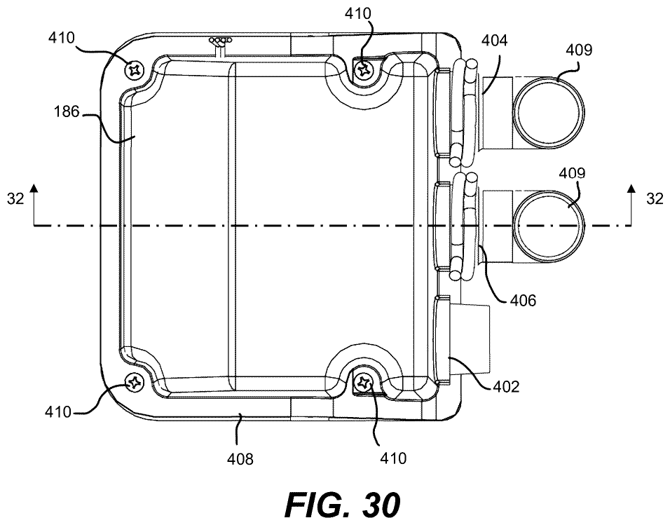

As shown in FIG. 7, in this embodiment, each blower 166₁, 166₂ is enclosed within a respective blower enclosure 186 that, together with the base portion 154 of the housing 152, defines a blower chamber 187 (FIG. 8). In use, air is drawn into each blower chamber 187 for distribution by the enclosed blower to different parts of the mattress 100. With reference to FIGS. 29 and 30 which illustrate an exemplary air supply unit including a given one of the blowers 166₁ enclosed within a corresponding blower enclosure 186, the blower enclosure 186 has two housing inlets 402, 404 through which air enters the blower enclosure 186 and a housing outlet 406 through which air exits the blower enclosure 186. Elbow connectors 409 may be connected to the housing inlets and outlets 402, 404, 406 for connection to other parts of the pneumatic control assembly 150 as will be explained in greater detail further below. A peripheral flange 408 of the blower enclosure 186 is affixed to the base portion 154 of the housing 152 by fasteners 410. A gasket 412 is disposed at an interface between the blower enclosure 186 and the base portion 154 to provide a seal therebetween.

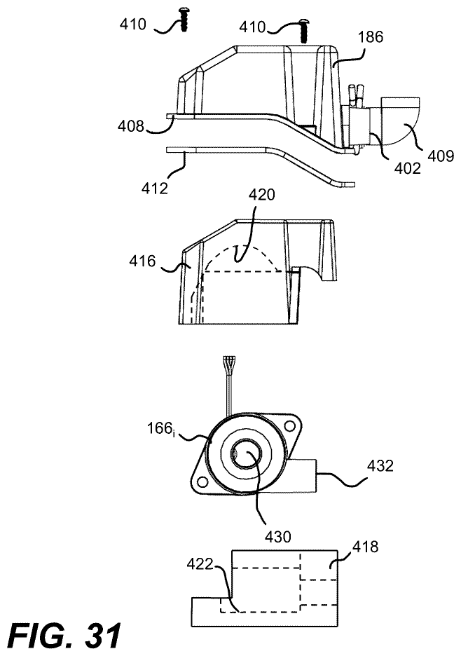

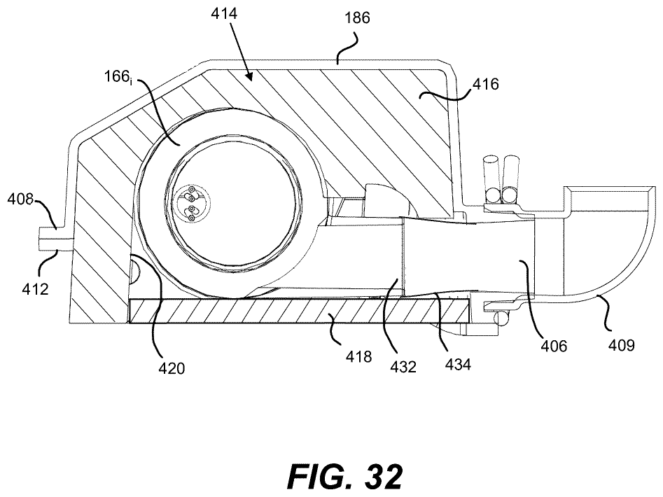

The air supply unit may be configured to limit the noise emitted by the operation of the corresponding blower 166₁, 166₂. More specifically, with particular reference to FIGS. 31 and 32, in this embodiment, the air supply unit includes an attenuating filler 414 that surrounds the blower 166ᵢ to fix the blower 166₁ in place within the blower chamber 187. The blower 166ᵢ is therefore not retained in place by fasteners as is typical in conventional pneumatic systems. For example, the blower 166ᵢ is detached from the base portion 154 of the housing 152. The blower 166ᵢ is rather held in place by the attenuating filler 414 filling a substantial amount of space within the blower chamber 187 so that the blower 166ᵢ cannot move due to the presence of the attenuating filler 414 extending from an outer surface of the blower 166ᵢ to an inner surface of the blower enclosure 186. In this embodiment, the attenuating filler 414 is made of a plurality of filler members including an upper filler member 416 and a lower filler member 418 which are disposed respectively above and below the blower 166ᵢ to complementarily surround the blower 166ᵢ. As shown in FIGS. 31 and 32, the filler members 416, 418 define respective recesses 420, 422 corresponding in part to a shape of the blower 166ᵢ so that the outer surfaces of the blower 166ᵢ partly match the inner surfaces of the filler members 416, 418 that define the recesses 420, 422. To that end, the recesses 420, 422 may be produced by molding the filler members 416, 418 to be a negative of the shape of the blower 166ᵢ. The filler members 416, 418 are also shaped to allow communication between the housing inlets 402, 404 and an inlet 430 (FIG. 31) of the blower 166ᵢ, and between the housing outlet 406 and an outlet 432 (FIGS. 31, 32) of the blower 166ᵢ. Notably, the filler members 416, 418 may form, together, channels through which air can freely flow to and from the blower inlet 430 and outlet 432. The attenuating filler 414 is made of a soft material that can attenuate vibration. In this embodiment, the attenuating filler 414 is made of foam. The foam of the attenuating filler 414 may have a density of approximately 7 lbs/ft³. In this example, the foam of the attenuating filler 414 has flame retardant properties. The attenuating filler 414 minimizes the vibrations of the blower 166ᵢ that could otherwise generate considerable noise if not attenuated.

While two filler members are provided in this embodiment, it is contemplated that a single filler member could be provided in other embodiments. For example, in some cases, a single filler member may be provided to overlie the blower 166ᵢ. In such cases, the blower 166ᵢ may be secured in place by a complementary shape of the filler member and the base portion 154 of the housing 152. Furthermore, a similar concept may be implemented for air supply devices other than a blower.

Furthermore, as shown in FIG. 32, in this embodiment, a flexible sleeve 434 connects the outlet 432 of the blower 166ᵢ to the housing outlet 406. The flexible sleeve 434 is made of a flexible fabric (e.g., spandex coated with thermoplastic polyurethane (TPU)). The flexible sleeve 434 could be fixed in place in various ways. In this example, one end of the flexible sleeve 434 is welded to the outlet 432 of the blower 166ᵢ to surround the outlet 432, while another end of the flexible sleeve 434 is welded to the blower enclosure 186 at the housing outlet 406. This provides an airtight connection between the blower 166ᵢ and the housing outlet 406. The flexible sleeve 434 minimizes vibrations flow that might otherwise be generated with a more rigid connector.

It is contemplated that, in other embodiments, other features may be disposed within the blower chamber 187, such as baffles for example, to limit the noise and/or vibration generated by the operation of the blowers 166₁, 166₂.

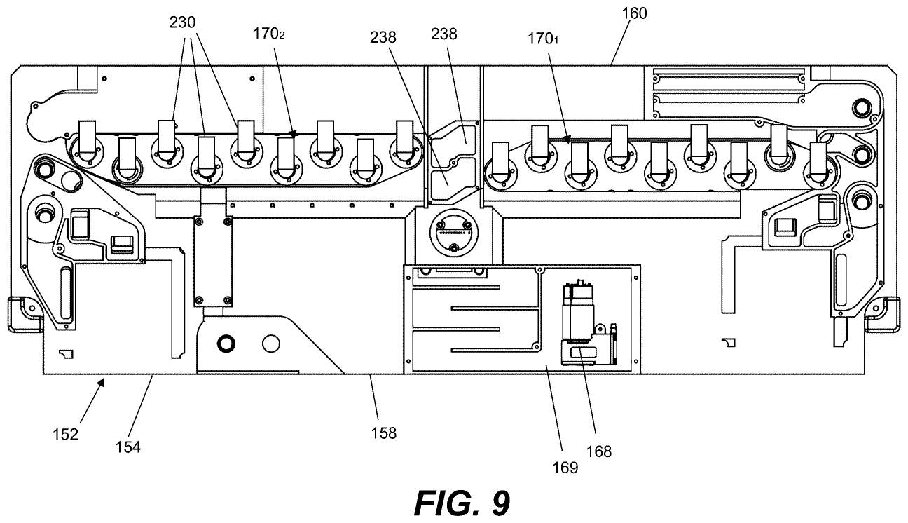

With reference to FIGS. 9 and 11, the pneumatic control assembly 150 has another air supply device, namely a compressor 168. The compressor 168 is used for piloting valves that selectively communicate the blowers 166₁, 166₂ with the different air-powered parts of the mattress 100. Compressors, in contrast with blowers, provide a low flow rate of air but at a high pressure. For instance, the compressor 168 may have a pressure capacity that is greater than 50 kPa. The pressure capacity of the compressor 168 may thus be 10 times or more greater than the pressure capacity of the blowers 166₁, 166₂. In particular, in this embodiment, the compressor 168 has a pressure capacity of approximately 100 kPa (i.e., approximately 1 bar). The compressor 168 may have a different pressure capacity in other embodiments. For instance, the pressure capacity of the compressor 168 may be between 50 kPa and 100 kPa inclusively. Furthermore, the flow rate of the compressor 168 may be less than 10 Lpm. In this example, the flow rate of the compressor 168 is approximately 5 Lpm. The flow rate of the compressor 168 may thus be 100 times less than the flow rate of the blowers 166₁, 166₂. The compressor 168 therefore supplies air at a greater pressure than the blowers 166₁, 166₂ but at a lower flow rate than the blowers 166₁, 166₂. As will be described in greater detail below, in this embodiment, the compressor 168 may also be selectively used to, under certain conditions, feed air to the different air-powered parts of the mattress 100 (instead of being exclusively used for piloting valves).

With reference to FIG. 9, in this embodiment, the compressor 168 is disposed within a compressor chamber 169 that is defined by the base portion 154 of the housing 152 on an underside thereof. A lid (not shown) is connected to the base portion 154 of the housing 152 to close off the compressor chamber 169. In use, when the compressor 168 is activated, air from an exterior of the pneumatic control assembly 150 is drawn into the compressor chamber 169 via an inlet aperture (not shown). A muffler may also be disposed within the compressor chamber 169 to limit the noise emitted by operation of the compressor 168.

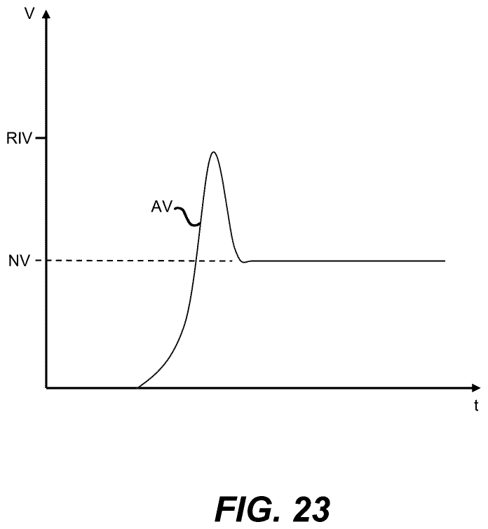

The compressor 168 may be electrically controlled in such a manner as to limit noise emitted thereby. Notably, in this embodiment, as exemplified by the graph of FIG. 23, the compressor 168 is operated at an applied voltage AV that is less than a rated input voltage RIV of the compressor 168. For example, the rated input voltage RIV may be approximately 24V. When starting the compressor 168, the applied voltage AV is increased to a peak voltage that may be equal to or less than the rated input voltage RIV to overcome an inertia of the compressor 168. The applied voltage AV is then lowered to a nominal voltage NV that is determined based on the output pressure required from the compressor 168. The nominal voltage NV may be significantly less than the rated input voltage RIV. For instance, according to one example, the nominal voltage NV may be 12V. By lowering the applied voltage AV to a value that is less than the rated input voltage RIV, the noise emitted by the compressor 168 may be limited. In this embodiment, the applied voltage AV of the compressor 168 is pulse width modulated.

The compressor 168 may be controlled conventionally in other embodiments (i.e., the applied voltage AV is either null or the rated input voltage RIV).

In this embodiment, the pneumatic control assembly 150 also includes reservoirs of pressurized air that are actively filled by one of the air supply devices. For instance, as shown in FIG. 11, the pneumatic system of the pneumatic control assembly 150 may include reservoirs 230, 231, 233 that are selectively filled by the compressor 168. The reservoirs 230, 231, 233 are provided to help maintain a more constant pressure in the pneumatic circuit that is fed by the compressor 168 (which may be referred to as a “high-pressure circuit”). In addition, the reservoirs 230, 231, 233 may also be provided as a fail-safe to close a “low-pressure circuit” of the pneumatic system (i.e., the circuit associated with the blowers 166₁, 166₂) in the event of a malfunction of the compressor 168 and/or of a valve. This may be helpful to ensure a minimum inflation level for at least some of the inflatable bladders of the mattress 100 in order to prevent the patient coming into contact with a rigid component of the bed 300.

As shown in FIGS. 7 and 11, in order to direct air from the air supply devices to the different air-powered parts of the mattress 100 (and vice-versa), the pneumatic control assembly 150 has first and second manifolds 170₁, 170₂ that are associated with the first and second blowers 166₁, 166₂ respectively. The manifolds 170₁, 170₂ are provided for fluidly connecting the air supply devices to the various air-powered parts of the mattress 100. Each manifold 170₁, 170₂ includes a plurality of manifold valves 172₁-172₉ that control air flow in and out of the air-powered parts of the mattress 100. Notably, each of the manifold valves 172₁-172₉ is associated with a corresponding air-powered part of the mattress 100 and is selectively fluidly connected thereto. By selectively opening the manifold valves 172₁-172₉, the associated air-powered parts of the mattress 100 are placed in fluid communication with a corresponding air supply device. As can be seen, in some cases, some inflatable bladders of the mattress 100 may be associated with more than one manifold valve. For instance, in this example, each of the left and right turning bladders 138 is selectively fluidly connected to the air supply devices by two of the manifold valves 172₁-172₉. This may allow a significant flow rate of air to be directed to the turning bladders 138 by opening both manifold valves that are associated therewith simultaneously. Alternatively, a single manifold valve could be associated therewith and have a configuration that allows a greater flow rate of air (e.g., a bigger outlet opening).

The manifolds 170₁, 170₂ also include respective inlet valves 176₁, 176₂, interconnection valves 178₁, 178₂ and control valves 179₁, 179₂. The inlet valves 176₁, 176₂ selectively fluidly connect the blowers 166₁, 166₂ to respective inlet apertures (not shown) through which exterior air is drawn into the pneumatic control assembly 150. As will be discussed below, the inlet valves 176₁, 176₂ may additionally be used to exhaust air therethrough to the exterior of the pneumatic control assembly 150 via the respective inlet apertures. The interconnection valves 178₁, 178₂ are provided to selectively fluidly interconnect the manifolds 170₁, 170₂ to each other. The control valves 179₁, 179₂ are provided for selectively blocking the inlets of the respective blowers 166₁, 166₂. This may be useful in certain operations to exhaust air for example via the inlet valves 176₁, 176₂ as will be described in more detail below. In this embodiment, as shown in FIG. 11, the pneumatic control assembly 150 includes solenoid valves 201₁, 201₂, 203₁, 203₂ for controlling air flow to respective pilot ports of the valves 176₁, 176₂, 178₁, 178₂. Other solenoid valves (not shown) control air flow from the compressor 168 and/or reservoir 230 to the pilot ports of the control valves 179₁, 179₂. More specifically, the inlet valves 176₁, 176₂ are pneumatically actuated by the compressor 168 or reservoir 230 via the solenoid valves 201₁, 201₂ that are controlled by controller 180 (FIG. 8). For example, when the solenoid valve 201₁ is closed, air flow from the compressor 168 fed into a pilot port of the first inlet valve 176₁ ceases, causing the first inlet valve 176₁ to open. Similar operations are executed to open the other inlet valve 176₂ via the solenoid valve 201₂, the interconnection valves 178₁, 178₂ via the solenoid valves 203₁, 203₂, and control valves 179₁, 179₂ via other solenoid valves (not shown) that control air flow to the pilot ports of the control valves 179₁, 179₂. The solenoid valves controlling air flow to the pilot ports of the control valves 179₁, 179₂ may be grouped with the other solenoid valves 201₁, 201₂, 203₁, 203₂, 205, 207 in the pneumatic diagram of FIG. 11. Some of the above-mentioned valves may be omitted in some embodiments. For instance, it is contemplated that the control valves 179₁, 179₂ may be omitted in some embodiments.

The construction of the manifolds 170₁, 170₂ will be described in greater detail further below.

With reference to FIGS. 7 and 8, the controller 180 of the pneumatic control assembly 150 is in communication with the blowers 166₁, 166₂ and the compressor 168 to control their operation. The controller 180 is configured to receive different inputs and, in response to those inputs, control the air supply devices. The controller 180 has a processor unit 182 for carrying out executable code, and a non-transitory memory unit 184 that stores the executable code in a non-transitory medium (not shown) included in the memory unit 184. The processor unit 182 includes one or more processors for performing processing operations that implement functionality of the controller 180. The processor unit 182 may be a general-purpose processor or may be a specific-purpose processor comprising one or more preprogrammed hardware or firmware elements (e.g., application-specific integrated circuits (ASICs), electrically erasable programmable read-only memories (EEPROMs), etc.) or other related elements. The non-transitory medium of the memory unit 184 may be a semiconductor memory (e.g., read-only memory (ROM) and/or random-access memory (RAM)), a magnetic storage medium, an optical storage medium, and/or any other suitable type of memory. While the controller 180 is represented as being one entity in this implementation, it is understood that the controller 180 could comprise separate entities for controlling components separately.

The controller 180 is also in communication with and controls a plurality of solenoid valves 174 of the pneumatic control assembly 150. Each solenoid valve 174 is associated with a corresponding manifold valve 172₁. As shown in FIGS. 7 and 8, in this embodiment, there are two subsets 175₁, 175₂ of the solenoid valves 174, the solenoid valves 174 of each subset 175₁, 175₂ being in communication with the manifold valves 172₁-172₉ of a respective manifold 170₁, 170₂. Notably, each solenoid valve 174 is connected between a pilot port of a respective manifold valve 172ᵢ and the compressor 168. The solenoid valves 174 are actuated by the controller 180 to selectively allow air flow from the compressor 168 to the pilot ports of the manifold valves 172₁-172₉, thus causing the compressor 168 to actuate the manifold valves 172ᵢ as determined by the controller 180. Each solenoid valve 174 is fluidly connected to a corresponding manifold valve 172ᵢ via tubing (not shown in FIGS. 7 and 8) extending between an outlet of the solenoid valve 174 and the pilot port of a manifold valve 172ᵢ. The solenoid valves 174 are normally open and therefore, without intervention from the controller 180 to actuate the solenoid valves 174, air flow from the compressor 168 (or reservoir 230) enters the respective pilot ports of the manifold valves 172₁-172₉, thereby closing the manifold valves 172₁-172₉. However, upon actuation of a given solenoid valve 174 to close that solenoid valve 174, the air flow to the pilot port of the corresponding manifold valve 172ᵢ is cut off and consequently the manifold valve 172ᵢ opens thereby fluidly communicating the corresponding blower 166ᵢ with the inflatable section of the mattress 100 associated with that manifold valve 172ᵢ. For example, if the controller 180 has determined that the pressure of the inflatable seat section 123B is to be increased, the controller 180 actuates the solenoid valve 174 that is in selective fluid communication with the manifold valve 172₁ in order for the air flow from the compressor 168 to the pilot port of the manifold valve 172₁ to be stopped, thereby opening the manifold valve 172₁ so that air from the blower 166₁ can flow through the manifold valve 172₁ to the inflatable seat section 123B.

The controller 180 is also in communication with the solenoid valves 201₁, 201₂, 203₁, 203₂ as well as with the solenoid valves that control air flow to the pilot ports of control valves 179₁, 179₂. Furthermore, with reference to FIG. 11, the reservoir 233 is provided to ensure that the solenoid valves 201₁, 201₂, 203₁, 203₂, 205, 207 (and the solenoid valves controlling air flow to the control valves 179₁, 179₂) are provided with a sufficient quantity of air to close the valves 176₁, 176₂, 178₁, 178₂, 179₁, 179₂, 220, 222 in case of failure of one or more of the solenoid valves 174 for example. This would close off fluid communication of the pneumatic control assembly 150 with the exterior via the inlet valves 176₁, 176₂ and the valves 220, 222 and thereby ensure that the air is not emptied from mattress 100. This may be useful to prevent the patient from coming into contact with a rigid component of the bed 300 in case of a component failure. Moreover, a check valve 177 collaborates with the reservoir 233 to ensure that the volume of air of the reservoir 233 remains available to the valves 201₁, 201₂, 203₁, 203₂, 205, 207. Similarly, the reservoir 231 is provided to ensure that the solenoid valves 174 are provided with a sufficient quantity of air to close the manifold valves 172₁-172₉ in case of failure of one or more of the solenoid valves 201₁, 201₂, 203₁, 203₂, 205, 207 (and the solenoid valves controlling air flow to the control valves 179₁, 179₂). Moreover, a check valve 181 collaborates with the reservoir 231 to ensure that the volume of air of the reservoir 231 remains available to the solenoid valves 174. In this embodiment, the reservoirs 231, 233 have a smaller volume than the reservoir 230.

The pneumatic control assembly 150 is operable in multiple operation modes that are selected by the controller 180. Notably, the controller 180 determines which operation mode to engage depending on the desired outcome at one or more air-powered parts of the mattress 100. In particular, in this embodiment, the operation modes that the controller 180 selectively implements include a direct feed mode, a dual-stage compression mode, a compressor feed mode and a deflate mode. One or more of these operation modes may be omitted in some embodiments.

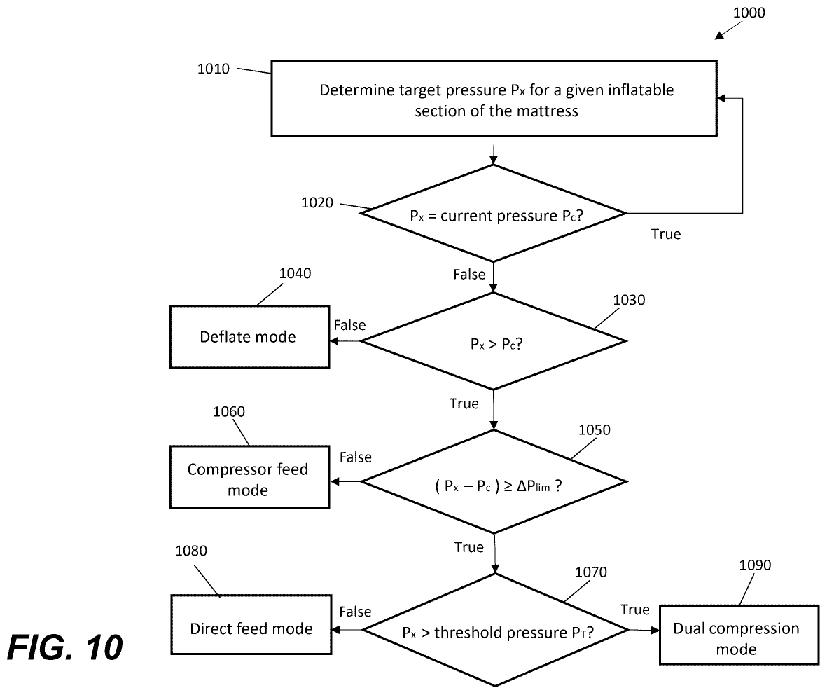

FIG. 10 illustrates an example of a method 1000 executed by the controller 180 to choose which of the operation modes to implement in order to achieve a desired target pressure Pₓ at the inflatable bladders of a given inflatable section of the mattress 100. The target pressure Pₓ may be any suitable pressure that the controller 180 has determined, at step 1010, should be implemented at a given inflatable section (e.g., the bladders of the back support section 136). The target pressure Pₓ may be determined based on one or more inputs such as a command received from a user input device such as an “increase firmness” button displayed on a touch screen of the bed or a “chair position” button of the bed for causing the bed to assume the chair position. In other cases, the target pressure Pₓ may be a pre-determined target pressure that is programmed into the controller 180 such as a start-up pressure that is to be implemented in the given inflatable section at initialization of the mattress 100. The skilled reader will understand that the target pressure Pₓ may be determined based on different variables in other embodiments.

With the target pressure Pₓ determined, the method proceeds to step 1020 where the controller 180 compares the target pressure Pₓ to a current pressure P_{c} in the given inflatable section to determine if the target pressure is equal to the current pressure P_{c}. The current pressure P_{c} of the given inflatable section may be detected by a pressure sensor (e.g., sensors 225 in FIG. 11) associated with the given inflatable section and communicated to the controller 180. If the target pressure Pₓ is equal to the current pressure P_{c} (i.e., no pressure adjustment needed), the method returns to step 1010 to proceed with the next pressure adjustment of an inflatable section of the mattress 100. The target pressure Pₓ may have a defined tolerance window (e.g., ±2 mm Hg) such that, if the current pressure P_{c} is within the tolerance window of the target pressure Pₓ, the current pressure P_{c} is determined to be equal to the target pressure Pₓ.

If the target pressure Pₓ is determined to be different from the current pressure P_{c}, the method proceeds to step 1030. At step 1030, the controller 180 determines if the target pressure Pₓ is greater than the current pressure P_{c}. If it is not (i.e., the target pressure Pₓ is less than the current pressure P_{c}), the method proceeds to step 1040 and the deflate mode is implemented by the controller 180 to decrease the pressure within the given inflatable section.

In the deflate mode, one of the blowers 166₁, 166₂ draws air from the given inflatable section and drives it outside of the pneumatic system of the mattress 100. As will be described in more detail below, in this embodiment, the air that is aspirated from an inflatable section of the mattress 100 associated with the first manifold 170₁ may be evacuated via the inlet valve 176₁ of the first manifold 170₁ and similarly, the air that is aspirated from an inflatable section of the mattress 100 associated with the second manifold 170₂ may be evacuated via the inlet valve 176₂ of the second manifold 170₂. The air drawn from the given inflatable section may be discharged via both the inlet valves 176₁, 176₂ when a large volume of air is to be evacuated from the given inflatable section. In some cases, the air drawn from the given inflatable section may be driven to a purge valve 220 (FIG. 11) that fluidly connects the blowers 166₁, 166₂ to the exterior of the pneumatic control assembly 150. In some cases, the air drawn from the given inflatable section may be driven to an internal space of the mattress 100 or a component of the mattress 100 other than an inflatable section via a discharge valve. For instance, the discharge valve may be a microclimate management valve 222 which is fluidly connected to the microclimate management layer 200 in order to drive the air thereto. This may be the case for example when a smaller volume of air is to be evacuated from the given inflatable section.

In this embodiment, the purge valve 220 and the microclimate management valve 222 are piloted by air flow from the compressor 168, or from the reservoir 230 that is filled by the compressor 168, via respective solenoid valves 207, 205 that are in communication with the controller 180. That is, the solenoid valves 205, 207 are selectively actuated to allow or restrict air flow from the compressor 168 or reservoir 230 to pilot ports of the microclimate management valve 222 and the purge valve 220 which causes actuation thereof. The reservoir 230 contains pressurized air thus providing a passive air supply that can actuate the air piloted valves of the pneumatic system. This may reduce the number of times the compressor 168 is activated during operation and help maintain a more uniform pressure in the high-pressure circuit of the pneumatic system. The reservoir 230 is selectively filled by the compressor 168 by actuating a control valve 185 (FIG. 11) controlled by controller 180 and which, when actuated, directs air flow from the outlet of the compressor 168 to the reservoir 230. It is contemplated that the reservoir 230 may be omitted in some embodiments.

With continued reference to FIG. 11, an example of operation of the pneumatic control assembly 150 in the deflate mode will now be described according to a scenario in which the second inflatable seat section 123B, associated with the manifold valve 172₁ of the first manifold 170₁, is to be depressurized. First, the manifold valve 172₁ is opened to allow air to be drawn therethrough from the inflatable seat section 123B. This is done by actuating the corresponding solenoid valve 174 of the subset 175₁ to cease air flow from the compressor 168 or reservoir 230 to the pilot port of the manifold valve 172₁. Then, the second interconnection valve 178₂ and the second control valve 179₂ are opened to communicate the opened manifold valve 172₁ of the first manifold 170₁ with the second blower 166₂, and the second blower 166₂ is activated. With the manifold valves 172₁-172₉ of the second manifold 170₂ closed and the first blower 166₁ deactivated, the first interconnection valve 178₁ is opened to communicate the second blower 166₂ with the first inlet valve 176₁ which is opened, while the first control valve 179₁ is closed. The air drawn from the inflatable seat section 123B is therefore discharged out of the pneumatic control assembly 150 through the inlet aperture associated with the first inlet valve 176₁. It is to be understood that the order of operations in the sequence may vary in other embodiments. The depressurization of the inflatable seat section 123B is stopped once a pressure sensor 225 associated with the inflatable seat section 123B indicates that the pressure in the inflatable seat section 123B has reached the target pressure Pₓ.

As mentioned above, in some cases, the air drawn from the inflatable section may be discharged via the microclimate management valve 222 or the purge valve 220. In such instance, instead of operating the valves as discussed above, the first interconnection valve 178₁ and inlet valves 176₁, 176₂ are closed, and the first blower 166₁ deactivated. The second interconnection valve 178₂ and the second control valve 179₂ are opened to allow air flow therethrough, thereby fluidly interconnecting the manifold 170₁ with the inlet of the second blower 166₂. The second blower 166₂ is then activated which causes the second blower 166₂ to draw air from the inflatable seat section 123B. One of the purge valve 220 and the microclimate management valve 222 is then opened to allow the second blower 166₂ to drive the air drawn from the inflatable seat section 123B thereto. It is to be understood that the order of operations in the sequence may vary in other embodiments.

The same process may be implemented to depressurize the other inflatable sections associated with the manifold valves 172₂-172₉ of the first manifold 170₁. Conversely, if an inflatable section associated with the second manifold 170₂ is to be depressurized in the deflate mode, the same process can be carried out by controlling counterpart components associated with the first and second blowers 166₁, 166₂ in the same manner. For instance, if the inflatable foot section 124 associated with the manifold valve 1725 of the second manifold 170₂ has to be depressurized, the manifold valve 1725 of the second manifold 170₂ is opened, the first interconnection valve 178₁ and the first control valve 179₁ are opened to communicate the opened manifold valve 1725 of the second manifold 170₂ with the first blower 166₁, and the first blower 166₁ is activated. With the manifold valves 172₁-172₉ of the first manifold 170₁ closed and the second blower 166₂ deactivated, the second interconnection valve 178₂ is opened to communicate the first blower 166₁ with the second inlet valve 176₂ which is opened, while the second control valve 179₂ is closed. The air drawn from the inflatable foot section 124 is therefore discharged out of the pneumatic control assembly 150 through the inlet aperture associated with the second inlet valve 176₂. Alternatively, the air can be driven to the microclimate management valve 222 or the purge valve 220 in a similar manner to that describe above.

The purge valve 220 and the microclimate management valve 222 may be integrated as part of the manifolds 170₁, 170₂ in other embodiments. For instance, each manifold 170₁, 170₂ may have a dedicated purge valve 220. In yet other embodiments, the purge valve 220 may be omitted. In such cases, large volumes of air may be discharged exclusively via the inlet valves 176₁, 176₂ as described above.

Returning now to FIG. 10, if at step 1030 the target pressure Pₓ is determined to be greater than the current pressure P_{c}, the method proceeds to step 1050. At step 1050, the controller 180 compares the pressure adjustment needed to the current pressure P_{c} of the given inflatable section to a threshold pressure adjustment ΔPₗᵢₘ. More specifically, the controller 180 determines if a difference between the target pressure Pₓ and the current pressure P_{c} is greater than the threshold pressure adjustment ΔPₗᵢₘ. As such, the controller 180 takes into account the magnitude of the pressure adjustment that is needed for the current pressure P_{c} to reach the target pressure Pₓ. If the pressure adjustment is equal to or less than the threshold pressure adjustment ΔPₗᵢₘ (i.e., if the pressure adjustment is small enough), the controller 180 proceeds to step 1060 where it implements the compressor feed mode whereby the air flow directed to the given inflatable section is provided by the compressor 168. In this example, the threshold pressure adjustment is 3 mm Hg.

In the compressor feed mode, the compressor 168 drives air to the manifolds 170₁, 170₂. To that end, in the compressor feed mode, the control valve 185 is in a position to direct air flow from the outlet of the compressor 168 to two fluid lines 187₁, 187₂ that are fluidly connected to the manifolds 170₁, 170₂ respectively. In this embodiment, the control valve 185 is a solenoid valve controllable by the controller 180 and its normal position is that associated with diverting air flow from the compressor 168 to the fluid lines 187₁, 187₂. The control valve 185 may be configured differently in other embodiments. As can be seen, the fluid lines 187₁, 187₂ bypass the solenoid valves 174 of the two subsets 175₁, 175₂, and therefore, in the compressor feed mode, the air supplied by the compressor 168 bypasses the solenoid valves 174 that are connected to the pilot ports of the manifold valves 172₁-172₉. In the compressor feed mode, a manifold valve 172₁ associated with the given inflatable section of the mattress 100 that is to be pressurized is opened to allow air from the corresponding manifold to enter the manifold valve 172ᵢ. The air flowing into the manifolds 170₁, 170₂ from the fluid lines 187₁, 187₂ then enters the manifold valve 172ᵢ that is opened and enters the associated inflatable section. The pressurization of the inflatable section is stopped once the pressure sensor 225 associated with the given inflatable section indicates that the pressure inside the inflatable section has reached the target pressure Pₓ. Since the flow rate of the compressor 168 is low, pressure within the given inflatable section increases slowly which may help in adjusting the pressure within the inflatable section more precisely.

In the compressor feed mode, the manifold valves 172₁-172₉ are piloted by air supplied by the reservoir 230. Notably, each solenoid valve 174 is supplied air by the reservoir 230, and the air is transmitted to the pilot ports of the manifold valves 172₁-172₉ to maintain them in a closed position. In order to open the selected manifold valve 172ᵢ, the associated solenoid valve 174 is actuated to cease air flow from reservoir 230 to the pilot port of the selected manifold valve 172ᵢ.

As will be understood, in the compressor feed mode, the blowers 166₁, 166₂ can remain deactivated since they are not used for driving air to the inflatable sections of the mattress 100. In some cases, at least one of the blowers 166₁, 166₂ could remain activated for example to feed air to the microclimate management layer 200 via the microclimate management valve 222.

Implementation of the compressor feed mode reduces the use of the blowers 166₁, 166₂ which can be helpful to limit noise emitted by the pneumatic control assembly 150 since the blowers 166₁, 166₂ are generally louder than the compressor 168. In particular, an intermittent noise generated by the blowers 166₁, 166₂ caused by turning the blowers 166₁, 166₂ on and off continuously to adjust the pressure of the inflatable sections of the mattress 100 can be avoided or otherwise minimized by the compressor feed mode. As will be appreciated, the reduction in noise can be helpful to reduce discomfort for a patient lying on the mattress 100. In addition, a risk of overheating the blowers 166₁, 166₂ from excessive use may be reduced by implementing the compressor feed mode. Furthermore, the compressor feed mode may be helpful in high altitude environments such as in a hospital located in a high altitude municipality. Notably, in such an environment, the output pressure of the blowers may be more limited and thus the compressor feed mode could be implemented to compensate for this limitation.

It is contemplated that the compressor feed mode may not be implemented in other embodiments. In such cases, the air flow provided by the blowers 166₁, 166₂ is driven to the inflatable sections whether the pressure adjustment required at the inflatable sections is small or large. As will be understood, steps 1050 and 1060 of method 1000 and the fluid lines 187₁, 187₂ shown in FIG. 11 that fluidly connect the compressor 168 to the manifold valves 172₁-172₉ may be omitted in such embodiments.

Returning to FIG. 10, if at step 1050, the pressure adjustment for the given inflatable section is determined to be greater than the threshold pressure adjustment ΔPₗᵢₘ, the controller 180 proceeds to step 1070. At step 1070, the controller 180 compares the target pressure Pₓ to a threshold pressure P_{T} in order to determine which of the direct feed mode or the dual-stage compression mode the controller 180 should implement to increase the pressure within the given inflatable section. The threshold pressure P_{T} is a predetermined pressure that is less than the pressure capacity of each blower 166₁, 166₂. In this example, the threshold pressure P_{T} is 2.7 kPa (i.e., half of the pressure capacity of each blower 166₁, 166₂). If the target pressure Pₓ is not greater than the threshold pressure P_{T}, the method proceeds to step 1080 where the direct feed mode is implemented by the controller 180 in order to increase the pressure of the inflatable section via a single one of the blowers 166₁, 166₂. In other words, the direct feed mode is implemented when the target pressure Pₓ is within the range of the pressure capacity of an individual one of the blowers 166₁, 166₂. In this example, the value of the threshold pressure P_{T} is less than the pressure capacity of each blower 166₁, 166₂ in order to ensure that the noise emitted by the blowers 166₁, 166₂ during operation will not be excessive in the direct feed mode as the blowers generate more noise the closer they get to operating at their maximum pressure capacity. The threshold pressure P_{T} may be a different proportion of the pressure capacity of each blower 166₁, 166₂ in other embodiments (e.g., 40% of the pressure capacity of each blower).

In the direct feed mode, a blower 166₁ or 166₂ draws air from a respective inlet of the pneumatic control assembly 150 and drives said air to the corresponding one of the manifolds 170₁, 170₂. Within the manifold, the air is then directed towards the manifold valve 172ᵢ corresponding to the given inflatable section. Thus, in the direct feed mode, the air provided to the given inflatable section of the mattress 100 is compressed a single time by one of the blowers 166₁, 166₂. The air discharged to the given inflatable section may thus be pressurized up to the maximum capacity of an individual one of the blowers 166₁, 166₂. The direct feed mode may thus also be referred to as a “single-stage compression mode”.

An example of operation in the direct feed mode will now be described in relation to pressurizing the back support section 136. With reference to FIG. 11, in the direct feed mode, the controller 180 opens the first inlet valve 176₁ and the first control valve 179₁ and activates the blower 166₁ to allow external air to be drawn into the pneumatic control assembly 150 via an inlet opening (not shown) and through a corresponding muffler 305. The muffler 305 is configured to limit noise generated by the air being drawn into the pneumatic control assembly 150. In the direct feed mode, the interconnection valves 178₁, 178₂ which are used to selectively interconnect the manifolds 170₁, 170₂ are closed. The blower 166₁ drives the air drawn from the exterior to the manifold 170₁. The manifold valve 172₇ is opened by actuating the corresponding solenoid valve 174 and thus the air is directed to the back support section 136 that is in selective communication with the manifold 170₁ via the manifold valve 172₇.

As will be appreciated, a similar operation may be performed to allow air flow from the blower 166₁ to the other air-powered parts of the mattress 100 that are associated with the other manifold valves 172₂-172₉.

Although the operation of the direct feed mode has been described in relation to the back support section 136, it will be appreciated that the same procedure is executed for increasing the pressure of the other inflatable sections associated with the manifold 170₁. Moreover, as mentioned above, multiple inflatable sections that are fluidly connected to the manifold 170₁ may be inflated at the same time by opening the corresponding manifold valves 172₁-172₉ of the manifold 170₁.

Furthermore, the reader will understand that the blower 166₂ may similarly distribute air in the direct feed mode to other air-powered parts of the mattress 100 that are associated with the manifold valves 172₁-172₉ of the second manifold 170₂. The operation of the direct feed mode in relation to the inflatable sections associated with the blower 166₂ will therefore not be described herein. Elements described above with regard to the functionality of the blower 166₁ (e.g., inlet valve 176₁) have been identified with similar reference numbers for the blower 166₂ (e.g., inlet valve 176₂), with a subscript “2” instead.

Returning to FIG. 10, if the target pressure Pₓ is greater than the threshold pressure P_{T}, the method proceeds to step 1090 where the controller 180 implements the dual-stage compression mode in order to use both blowers 166₁, 166₂ to increase the pressure of the given inflatable section of the mattress 100. In other words, when the target pressure Pₓ exceeds the pressure capacity of a single blower 166₁, 166₂, the dual-stage compression mode is engaged whereby the blowers 166₁, 166₂ are fluidly connected in series to enable two stages of compression by the blowers 166₁, 166₂.

The dual-stage compression mode will now be described in greater detail with reference to FIG. 11. In order to fluidly connect the two blowers 166₁, 166₂, one of the interconnection valves 178₁, 178₂ is opened to fluidly connect the outlet of one blower with the inlet of the other blower. The selection of which interconnection valve 178₁, 178₂ to open depends on the inflatable section that is going to be pressurized. If the inflatable section to be pressurized is associated with one of the manifold valves 172₁-172₉ of the first manifold 170₁, then the first interconnection valve 178₁ is opened and the second interconnection valve 178₂ is closed so that the first blower 166₁ can ultimately supply air to the first manifold 170₁ (i.e., the first blower 166₁ provides the last stage of compression after the second blower 166₂). Notably, if the first interconnection valve 178₁ is open, then the outlet of the second blower 166₂ is in communication with the inlet of the first blower 166₁ (with the first control valve 179₁ being opened). If, on the other hand, the inflatable section to be pressurized is associated with one of the manifold valves 172₁-172₉ of the second manifold 170₂, then the second interconnection valve 178₂ is opened and the first interconnection valve 178₁ is closed so that the second blower 166₂ can ultimately supply air to the second manifold 170₂. As will be appreciated, if the second interconnection valve 178₂ is open (with the second control valve 179₂ being opened), then the outlet of the first blower 166₁ is in communication with the inlet of the second blower 166₂.

Thus, if for example, the back support section 136 associated with the manifold valve 172₇ of the first manifold 170₁ is to be pressurized in the dual-stage compression mode, the manifold valve 172₇ is opened, the first inlet valve 176₁ is closed (to disconnect the first blower 166₁ from the corresponding inlet opening), the first interconnection valve 178₁ and the first control valve 179₁ are opened, the second interconnection valve 178₂ is closed, and the second inlet valve 176₂ and second control valve 179₂ are opened (to fluidly connect the second blower 166₂ to the corresponding inlet opening). The manifold valves 172₁-172₉ of the second manifold 170₂ are closed so that air flow from the second blower 166₂ is directed to the first blower 166₁. The second blower 166₂ is activated and thus the second blower 166₂ draws air through the inlet valve 176₂ and drives the air to the first blower 166₁, where the air is compressed again by the first blower 166₁. The first blower 166₁ thus drives the air to the open manifold valve 172₇ and thus to the back support section 136. As will be appreciated, the air that is fed to the back support section 136 is compressed two times, namely one time by each blower 166₁, 166₂.

As will be appreciated, more than one inflatable section of the mattress 100 may be inflated at the same time in the dual-stage compression mode. For instance, multiple manifold valves of the same manifold could be opened to feed air to their associated inflatable sections that has been compressed by both blowers 166₁, 166₂.

It is contemplated that in other embodiments in which the dual compression provided by the blowers 166₁, 166₂ is not deemed necessary (i.e., the target pressure Pₓ is not expected to exceed the capacity of a single blower), the pneumatic control assembly 150 could include a single blower. For example, the single blower could be used to pressurize and depressurize all of the inflatable sections of the mattress 100.

Conversely, it is also contemplated that, in some embodiments, the direct feed mode may be omitted such that the controller 180 operates the pneumatic control assembly 150 in the dual-stage compression mode in all cases in which one of the inflatable sections is to be pressurized (unless the compressor feed mode is also implemented as described above). This may be done for example to reduce the noise emitted by the blowers 166₁, 166₂ since they tend to generate more noise when they operate closer to their maximum pressure capacity.

It is to be understood that the method 1000 is just an example of a process for determining which operation mode the controller 180 should implement, and that the method 1000 could be formulated differently to achieve a similar result. As an example, the method 1000 may instead calculate a difference between the target pressure P_{T} and the current pressure P_{c}, and categorize the result to determine the operation mode to implement. Moreover, the order of the steps of the method 1000 may be different in other embodiments. Furthermore, while the operation modes have been generally described in relation to one inflatable section having to undergo a pressure adjustment, the method 1000 and the operation modes can be executed simultaneously for multiple inflatable sections of the mattress 100.

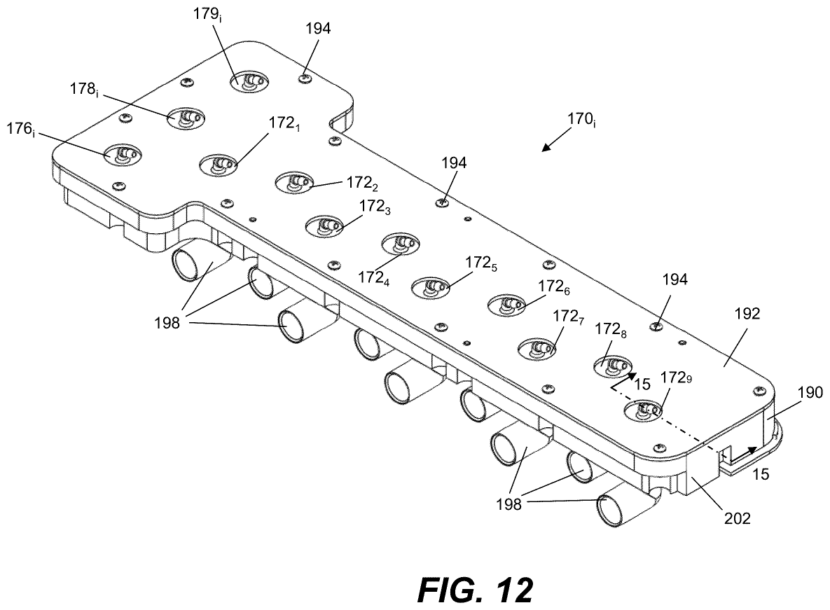

The construction of the manifolds 170₁, 170₂ will now be described in greater detail with reference to FIGS. 12 to 14. In this embodiment, the manifolds 170₁, 170₂ are identical to one another and thus a single one of the manifolds 170₁, 170₂ (which will be referred to as manifold 170₁) will be described herein. The manifold 170; has a main body 190 that receives respective ones of the manifold valves 172₁-172₉ therein. The main body 190 also receives a corresponding inlet valve 176ᵢ, interconnection valve 178ᵢ and control valve 179₁. The main body 190 has an inner lateral end 202 and an outer lateral end 204 opposite the inner lateral end 202. The inner and outer lateral ends 202, 204 correspond to the inner and outer lateral ends of the manifold 170ᵢ. In use, as shown in FIG. 8, the outer lateral end 204 is disposed near the right end 164 of the housing 152 while the inner lateral end 202 is disposed near a centerline of the housing 152 that bisects a width of the housing 152. Furthermore, in use, the first and second manifolds 170₁, 170₂ are oriented such that their inner lateral ends 202 are closer to each other than the outer lateral ends 204.

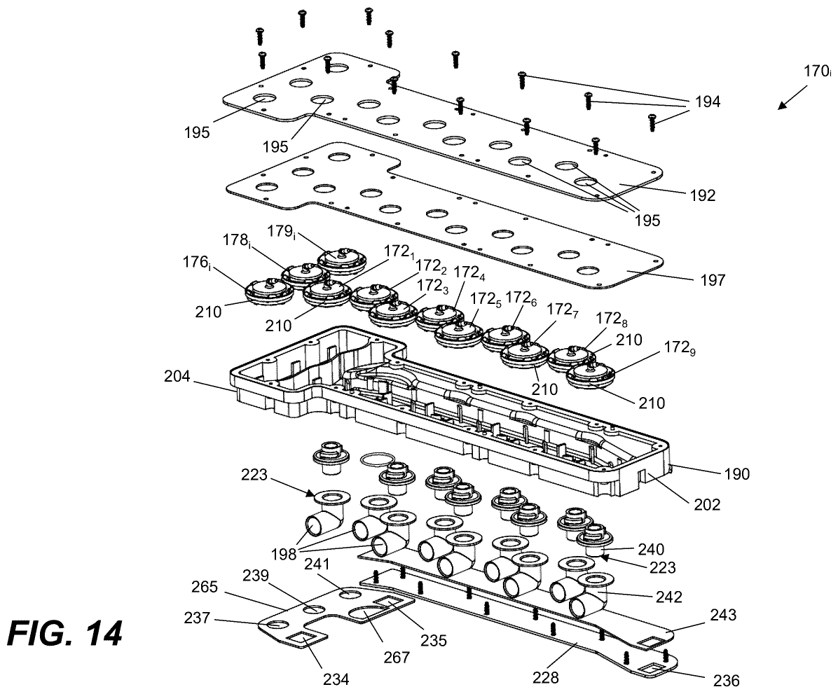

An upper cover 192 of the manifold 170ᵢ is secured to the main body 190 by multiple fasteners 194. As best shown in FIG. 14, the upper cover 192 defines a plurality of circular openings 195 through which part of each manifold valve 172₁-172₉, and each valve 176₁, 178₁, 179₁ protrudes. A gasket 197 is disposed between the upper cover 192 and the main body 190 to provide a seal along an interface between the cover 192 and the main body 190, as well as between the upper cover 192 and the valves 172₁-172₉, 176₁, 178₁, 179₁. The gasket 197 defines openings corresponding to the openings 195 of the upper cover 192.

A lower cover 265 is secured to an underside of the main body 190 and defines respective openings 237, 239, 241 for the outlets of each of the valves 176ᵢ, 178ᵢ and 179ᵢ to protrude therefrom.

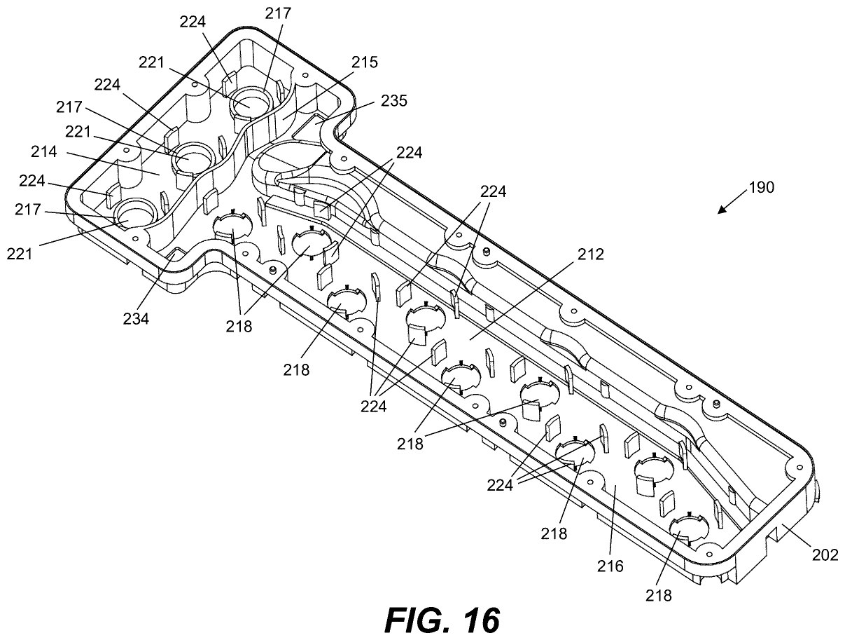

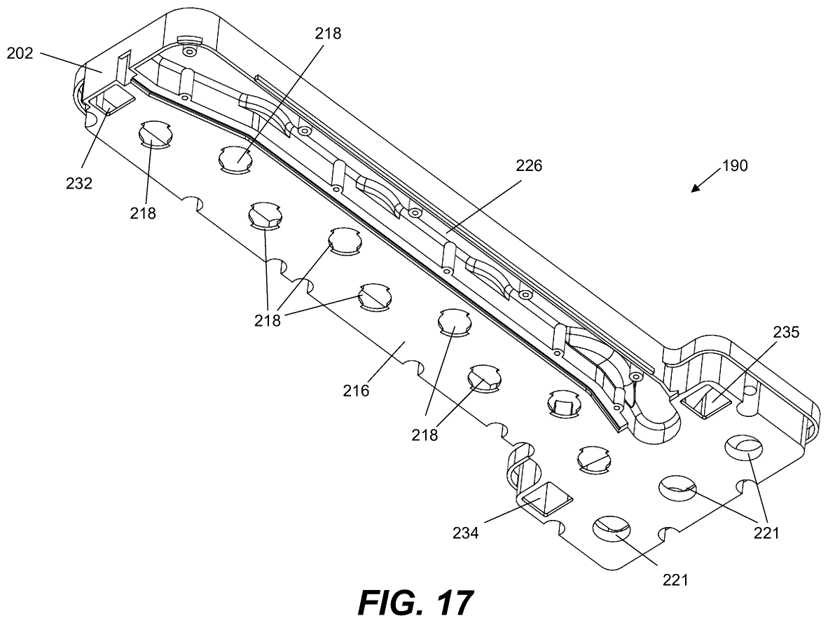

The main body 190 is shown in greater detail in FIGS. 16 and 17. As can be seen, the main body 190 defines a main valve chamber 212 which receives the manifold valves 172₁-172₉. The main body 190 also defines a secondary valve chamber 214 that is separated from the main chamber 212 by a dividing wall 215. The secondary valve chamber 214 is disposed adjacent to the outer lateral end 204. The secondary valve chamber 214 receives the inlet valve 176ᵢ, the interconnection valve 178ᵢ and the control valve 179₁. The main and secondary valve chambers 212, 214 are defined on an upper side of the main body 190 and are closed off by the upper cover 192 and the gasket 197.

The main body 190 has a bottom wall 216 that defines a plurality of openings, including valve openings 218 opening into the main chamber 212 and valve openings 221 opening into the secondary valve chamber 214. As will be explained in greater detail further below, the valve openings 218 are shaped to help orient the insertion of corresponding connectors 223 (FIG. 14). In particular, each valve opening 218 has a central circular portion and two wing portions extending from the circular portion. Furthermore, as shown in FIG. 17, the bottom wall 216 also defines an inner connecting aperture 232 near the inner lateral end 202 that opens into the main chamber 212 of the manifold 170ᵢ, and two outer connecting apertures 234, 235 that are closer to the outer lateral end 204 (near the dividing wall 215) that also open into the main chamber 212. The connecting apertures 234, 235 are distanced from each other in the longitudinal direction of the manifold 170ᵢ. The connecting apertures 232, 234, 235 are provided for fluidly connecting the main chamber 212 to other parts of the manifold 170ᵢ (e.g., the secondary valve chamber 214) or to other parts of the pneumatic control assembly 150, as will be described in greater detail below.

The connecting apertures 234, 235 are aligned with respective openings of the lower cover 265.

As shown in FIG. 16, valve supports 224 protrude from the bottom wall 216 for supporting the manifold valves 172₁-172₉ and the valves 176ᵢ, 178ᵢ, 179₁. Three valve supports 224 are disposed around each valve opening 218, 221 for supporting a corresponding valve.

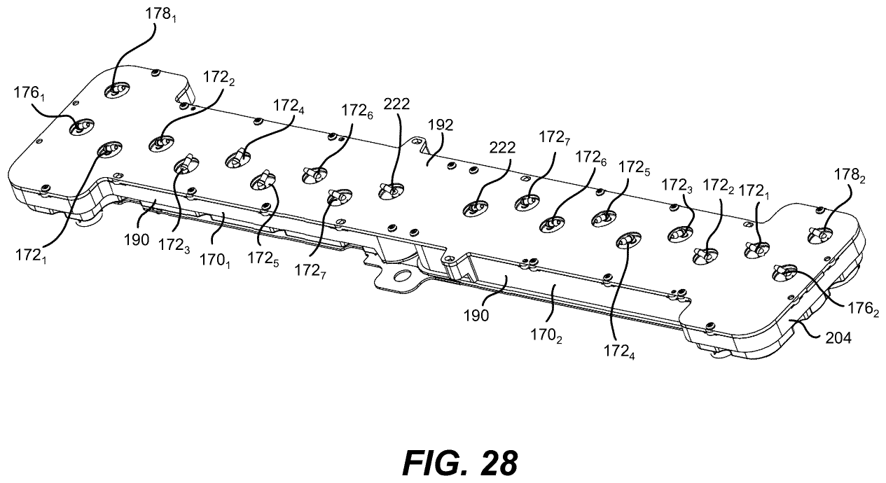

It is contemplated that, in some embodiments, the manifolds 170₁, 170₂ could share a common upper cover 192 as shown in the alternative embodiment illustrated in FIG. 28. In particular, as shown in FIG. 28, the common upper cover 192 is affixed to the main body 190 of each of the manifolds 170₁, 170₂ so as to close off the main chamber 212 and the secondary valve chamber 214 of each of the manifolds 170₁, 170₂. Similarly, the underlying gasket 197 (not shown in FIG. 28) extends across both manifolds 170₁, 170₂ to form a common gasket. This configuration may provide an improved seal along the top of the manifolds 170₁, 170₂. The lower cover 265 could similarly be a common lower cover that is fixed to the main bodies 190 of both manifolds 170₁, 170₂.

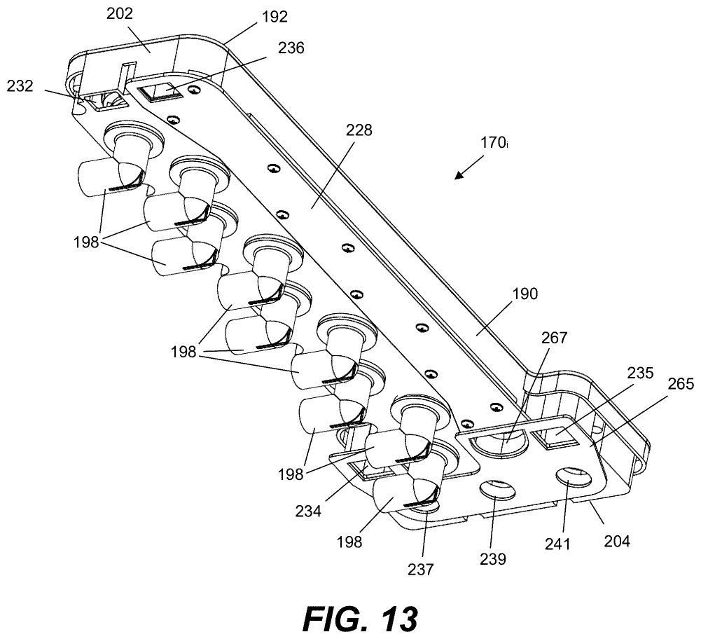

As best shown in FIG. 17, on the underside of the main body 190, the main body 190 defines an interconnection channel 226 extending generally in a lateral direction of the manifold 170ᵢ. In use, the interconnection channel 226 is covered by a cover 228 (FIG. 13) that is fastened to the main body 190. As shown in FIG. 14, a gasket 243 is disposed between the cover 228 and the main body 190 to provide a seal therebetween. The cover 228 defines a connecting aperture 236 near the inner lateral end 202 of the main body 190 for providing access to the interconnection channel 226. The lower cover 265 also defines an aperture 267 (FIGS. 13, 14) aligned with the interconnection channel 226, at an end of the interconnection channel 226 opposite the connecting aperture 236. The interconnection channel 226 is used for fluidly connecting the two manifolds 170₁, 170₂. In particular, the interconnection channel 226 of the first manifold 170₁ is fluidly connected to the main chamber 212 of the second manifold 170₂ while the interconnection channel 226 of the second manifold 170₂ is fluidly connected to the main chamber 212 of the first manifold 170₁. To that end, the connecting aperture 236 of the first manifold 170₁ is fluidly connected to the inner connecting aperture 232 of the second manifold 170₂, while the connecting aperture 236 of the second manifold 170₂ is fluidly connected to the inner connecting aperture 232 of the first manifold 170₁. Notably, with reference to FIG. 9, in this embodiment, the fluid connection between the connecting apertures 232, 236 of the first and second manifolds 170₁, 170₂ is provided by channels 238 defined by the base portion 154 of the housing 152 of the pneumatic control assembly 150. The channels 238 are covered by a lid (not shown) fixed to the underside of the base portion 154 of the housing 152.

The outer connecting apertures 234, 235 are provided for fluidly connecting the main chamber 212 of the manifold 170ᵢ with the corresponding blower 166₁. Notably, the outer connecting aperture 234, 235 that is closest to the blower 166ᵢ corresponding to that manifold 170ᵢ (i.e., that feeds that manifold 170; in the direct feed mode) is used for fluidly connecting the main chamber 212 with the corresponding blower 166₁. An internal channel (not shown) defined by the base portion 154 of the housing 152 establishes the fluid connection between the main chamber 212 (via the corresponding outer connecting aperture 234, 235) and the blower chamber 187 (FIG. 8) in which the corresponding blower 166₁ is disposed. The other outer connecting aperture 234, 235 (i.e., the one that is furthest from the corresponding blower 166₁) is provided only so that the same manifold structure can be used for both manifolds 170₁, 170₂ since the manifolds 170₁, 170₂ are oriented such that they are rotationally offset by 180 relative to each other.

With reference to FIG. 14, in this embodiment, each manifold valve 172₁-172₉ includes a valve module 210 that is received within the main chamber 212 defined by the main body 190, and an associated connector 223 that is fixed to the main body 190 and protrudes from the underside thereof. The valve module 210 is actuatable to selectively fluidly connect the main chamber 212 with the air-powered part to which the associated connector 223 is connected.

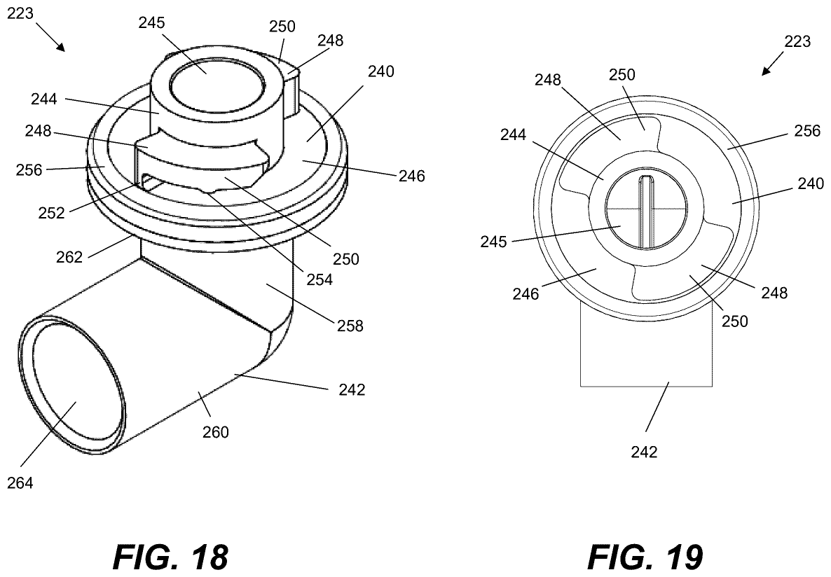

As shown in FIGS. 18 and 19, in this example, each connector 223 includes a first connector portion 240 and a second connector portion 242 (shown disassembled from each other in FIG. 14). The first connector portion 240 has a cylindrical body 244 and a flange 246 extending around a midsection of the cylindrical body 244. An upper end of the cylindrical body 244 defines an opening 245 which, as will be explained in more detail below, is selectively blocked by the corresponding manifold valve 172ᵢ to allow or prevent air flow therethrough. Two wings 248 extend from the cylindrical body 244 opposite from each other, on an upper side of the flange 246. Each wing 248 is curved around a same axis as the cylindrical body 244 and has a horizontal portion 250 and an abutting portion 252. The horizontal portion 250 is spaced from the flange 246 and extends generally parallel to the flange 246. The abutting portion 252 extends vertically downwardly from the horizontal portion 250 and is connected to the flange 246. The horizontal portion 250 may have a protruding ridge 254 extending from a lower surface of the horizontal portion 250. An O-ring 256 is disposed on the upper side of the flange 246, around a circumferential edge thereof, to provide a seal against the main body 190 of the manifold 170₁.

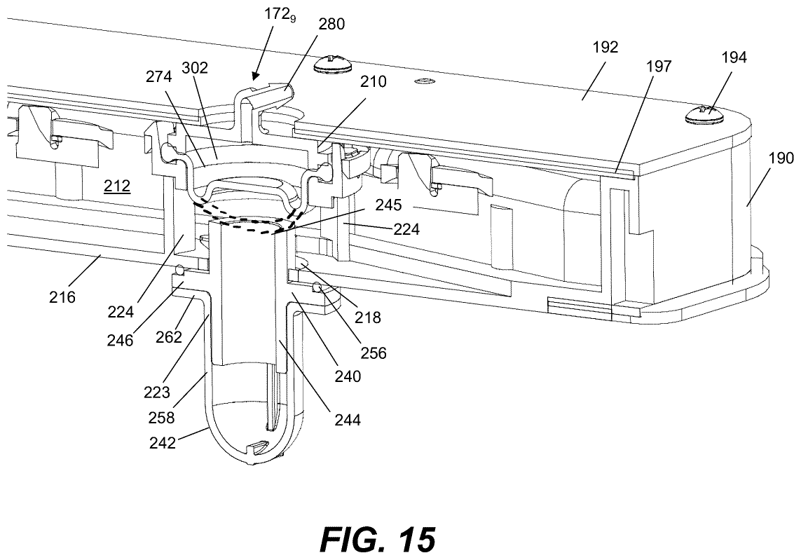

The second connector portion 242 of each connector 223 is a tubular elbow having a vertical portion 258 and a horizontal portion 260. A flange 262 extends circumferentially around the upper end of the vertical portion 258. The flange 262 is connected (e.g., welded or mechanically fastened) to the flange 246 of the first connector portion 240. As shown in FIG. 15, part of the cylindrical body 244 of the first connector portion 240 is received into the vertical portion 258 of the second connector portion 242. In use, the horizontal portion 260 is engaged by pneumatic tubing (not shown) that fluidly connects the connector 223 to the associated air-powered part of the mattress 100. For example, part of the pneumatic tubing may surround part of the horizontal portion 260 and be snugly fitted therewith. As shown in FIG. 18, the horizontal portion 260 has an end that defines an opening 264 through which air is discharged to the associated air-powered part of the mattress 100 (e.g., an inflatable section or the microclimate management layer 200). Thus, air that enters the opening 245 of the first connector portion 240 is discharged via the opening 264 of the second connector portion 242.

It is contemplated that, in some embodiments, the second connector portion 242 may be omitted. In such cases, the pneumatic tubing could be directly connected to the first connector portion 240 for example.

With reference to FIG. 15, each connector 223 is fixed to the main body 190 by aligning the wings 248 with the wing portions of a corresponding valve opening 218 and inserting the cylindrical body 244 therein such that the cylindrical body 244 protrudes into the main chamber 212 of the main body 190. The connector 223 is then rotated counterclockwise until the bottom wall 216 of the main body 190 contacts the abutting portions 252 of the wings 248. The protruding ridges 254 of the horizontal portions 250 of the wings 248 may help secure the connector 223 in place. The O-ring 256 provides a seal along the interface of the connector 223 with the main body 190, namely along the lower surface of the main body 190.

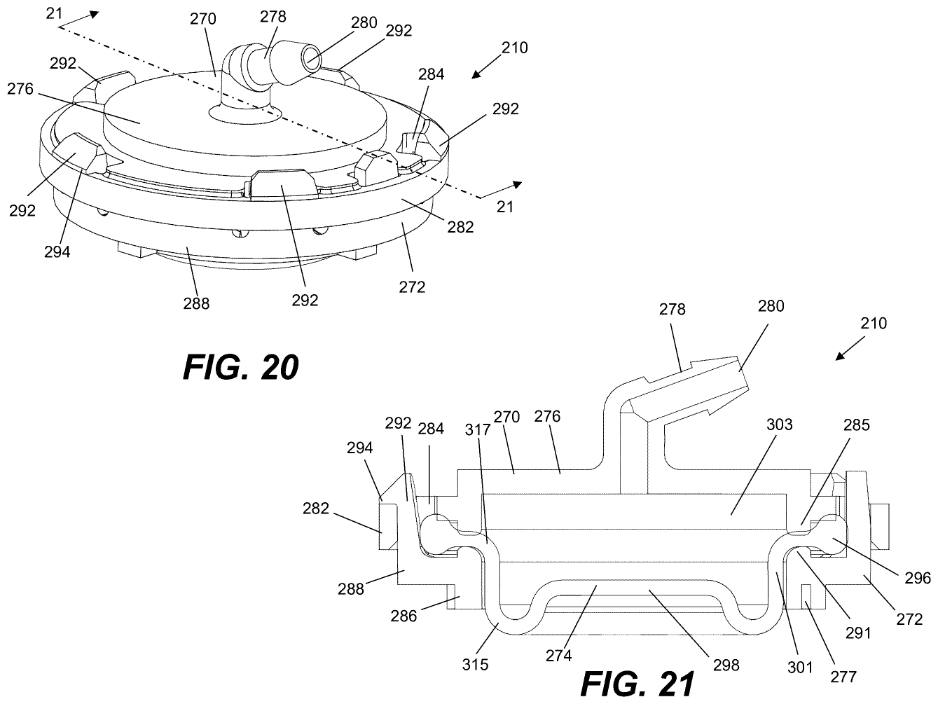

With reference to FIGS. 20 to 22, the valve module 210 of each manifold valve 172ᵢ includes an upper member 270, a lower member 272 and a diaphragm 274 disposed therebetween. The upper member 270 has a central portion 276 and an elbow connector 278 extending upwardly from the central portion 276. The elbow connector 278 defines a pilot port 280 of the valve module 210 for piloting the respective manifold valve 172ᵢ. In use, pneumatic tubing is connected to the elbow connector 278 to fluidly connect a corresponding solenoid valve 174 thereto as explained above and as shown schematically in FIG. 11. The upper member 270 also has a peripheral annular portion 282 extending radially outwardly from the central portion 276. A plurality of openings 284 are defined between the central portion 276 and the peripheral annular portion 282. As will be explained below, the openings 284 are used for interlockingly secure the upper member 270 to the lower member 272.

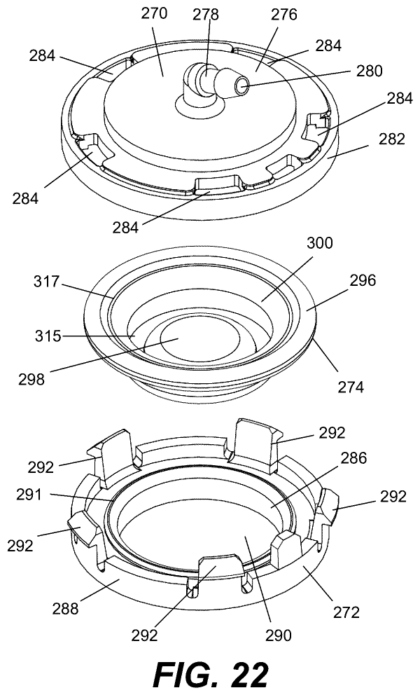

The lower member 272 is generally annular and has a central rim portion 286 and an outer peripheral portion 288 extending outwardly therefrom. The central rim portion 286 defines a central aperture 290 (FIG. 22) and has an upwardly extending annular ridge 291 (FIG. 21). A plurality of detents 292 extend upwardly from the outer peripheral portion 288 to engage the upper member 270. In particular, the detents 292 are inserted into corresponding ones of the openings 284 of the upper member 270 to retain the upper and lower members 270, 272 together. To that end, each detent 292 has a protruding edge 294 that, when the detent 292 is inserted into the corresponding opening 284, engages an upper surface of the peripheral annular portion 282 of the upper member 270. The detents 292 are thus prevented from disengaging the upper member 270 unless the detents 292 are forcibly pushed inwardly so that the detents 292 can be removed from openings 284.

With reference to FIGS. 21 and 22, the diaphragm 274 of each valve module 210 has an outer peripheral portion 296 and a central portion 298 that are connected by a wall portion 301 extending therebetween. The wall portion 301 extends vertically between the outer peripheral portion 296 and the central portion 298. In particular, the wall portion 301 has a first end 315 (which can be referred to as a “lower end” in this embodiment) that is connected to the central portion 298, and a second end 317 (which can be referred to as an “upper end” in this embodiment) that is connected to the outer peripheral portion 296. The diaphragm 274 is generally cup-shaped as the outer peripheral portion 296 and the central portion 298 are disposed at different heights. In particular, as can be seen in FIG. 21, in this embodiment, a cross-sectional profile of the diaphragm 274 is generally W-shaped, namely as the central portion 298 is vertically closer to the outer peripheral portion 296 than the first (lower) end of the wall portion 301 (i.e., the height between the outer peripheral portion 296 and the first (lower) end of the wall portion 301 is greater than the height between the outer peripheral portion 296 and the central portion 298. This shape may be helpful to prevent or otherwise minimize a permanent deformation of the diaphragm 274 during use, which may be more likely for example if the central portion 298 were at the same vertical height as the lower end of the wall portion 301. The diaphragm 274 is made of a pliable material (e.g., silicone) that is able to deform and bias back to its original shape. The diaphragm 274 may be made by molding, such as by injection molding or transfer molding.

The diaphragm 274 is fixed between the upper and lower members 270, 272 by positioning its central portion 298 into the central aperture 290 of the lower member 272 such that the outer peripheral portion 296 sits on the lower member 272. The upper member 270 is then engaged with the lower member 272 as mentioned above via the detents 292 and openings 284. Once the upper member 270 is engaged with the lower member 272, the diaphragm 274 is fixed therebetween and forms, together with the upper member 270, an inner chamber 303 (FIG. 21) of the valve module 210. The inner chamber 303 is accessible via the pilot port 280. As can be seen in FIG. 21, part of the diaphragm 274 is compressed between the annular ridge 291 of the lower member 272 and a lower annular ridge 285 of the upper member 270. Moreover, the outer peripheral portion 296 is compressed and provides a seal for the inner chamber 303 of the valve module 210. As will be described with respect to another embodiment further below, the diaphragm 274 could be set in a different orientation than that described above.

With reference to FIG. 15, each valve module 210 is seated on three corresponding valve supports 224 surrounding one of the valve openings 218. The lower member 272 of each valve module 210 has recesses 277 (one of which is shown in FIG. 21) in which the upper ends of the valve supports 224 are inserted. The valve supports 224 are thus used as positioning features for the valve module 210. Once the valve module 210 is seated on the valve supports 224, the valve module 210 is aligned with the corresponding connector 223. More specifically, the diaphragm 274 is generally concentric with the cylindrical body 244 of the outlet connector 223. When air is not supplied to the pilot port 280 of the valve module 210, the diaphragm 274 is in the position shown in solid lines in FIG. 15, corresponding to the open position of the manifold valve 172ᵢ, whereby the main chamber 212 of the manifold 170ᵢ is in fluid connection with the connector 223. The diaphragm 274 is therefore biased by default to the open position of the manifold valve 172ᵢ. Air can thus enter and exit the main chamber 212 of the manifold 170₁ via the open manifold valve 172ᵢ. Conversely, when air is supplied to the pilot port 280, the diaphragm 274 deforms to the position shown in dashed lines in FIG. 15 (corresponding to the closed position of the manifold valve 172₁), in which the diaphragm 274 blocks the opening 245 of the connector 223, thereby fluidly disconnecting the main chamber 212 of the manifold 170ᵢ from the connector 223. As mentioned above, in this embodiment, the manifold valve 172₁ is normally in the closed position, and when air flow to the pilot port 280 thereof ceases (due to actuation of the corresponding solenoid valve 174), the manifold valve 172ᵢ moves to the open position. It is contemplated that, in other embodiments, the diaphragm 274 could be biased to be in the closed position shown in dashed lines in FIG. 15 in other embodiments. For instance, in such cases, instead of feeding air into the pilot port 280 of the valve module 210 to block air flow to the connector 223, air may be vacuumed from the pilot port 280 to place the diaphragm 274 in the open position of the manifold valve 172ᵢ, thereby allowing air flow through the connector 223.

The manifold valves 172₁-172₉ may be relatively quiet in operation because they integrate a diaphragm. Notably, operation of the manifold valves may be quieter than that of solenoid valves that are typically used for controlling air flow in inflatable mattresses. Moreover, the modular design of the manifold valves 172₁-172₉ may make the assembly of the manifold 170ᵢ relatively simple.

It is contemplated that the manifold valves 172₁-172₉ could be configured differently in other embodiments. For instance, in some cases, the relationship between the upper and lower members 270, 272 of the valve module 210 may be inversed such that the upper member 270 has the detents and the lower member 272 has the corresponding openings for receiving the detents.

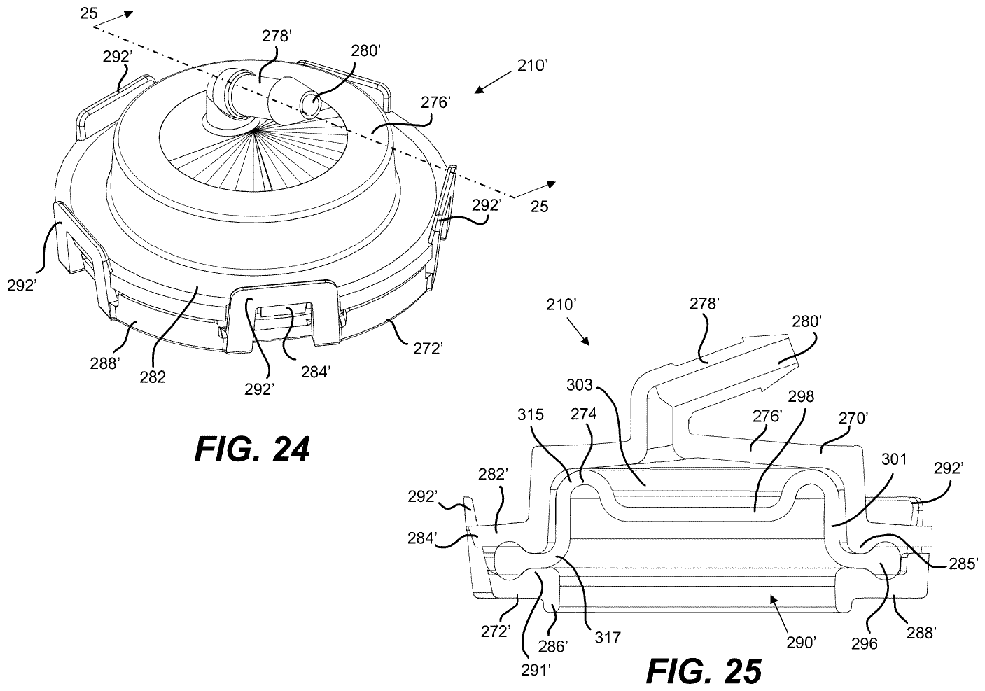

For instance, FIGS. 24 to 26 illustrate a valve module 210′ according to an alternative embodiment. The valve module 210′ has an upper member 270′, a lower member 272′ and the diaphragm 274 disposed therebetween. The upper member 270′ has a central portion 276′ and a peripheral annular portion 282′ extending radially outwardly from the central portion 276′. An elbow connector 278′ extends upwardly from the central portion 276′ and defines a pilot port 280′ of the valve module 210′ for piloting the respective manifold valve 172ᵢ. The upper member 270′ is generally-cup shaped as an upper end of the central portion 276′ being disposed at a different height from the peripheral annular portion 282′. In this embodiment, the peripheral annular portion 282′ includes tongues 284′ disposed at a radial edge of the peripheral annular portion 282′ and which are used for interlockingly securing the upper member 270′ to the lower member 272′. In this example, five tongues 284′ are provided, spaced equally circumferentially about the peripheral annular portion 282′.

The lower member 272′ is generally annular and has a central rim portion 286′ and an outer peripheral portion 288′ extending outwardly therefrom. As best shown in FIG. 25, the central rim portion 286′ defines a central aperture 290′ and has an upwardly extending annular ridge 291′. A plurality of detents 292′ extend upwardly from the outer peripheral portion 288′ to engage the upper member 270′. In particular, each detent 292′ defines an opening 293′ for receiving a corresponding one of the tongues 284′ of the upper member 270′. Notably, once the detents 292′ engage the tongues 284′ by inserting the tongues 284′ into the openings 293′, the upper and lower members 270′, 272′ are secured to each other. The detents 292′ are prevented from disengaging the upper member 270′ unless the detents 292′ are forcibly pushed outwardly so that the tongues 284′ can be removed from openings 293′.

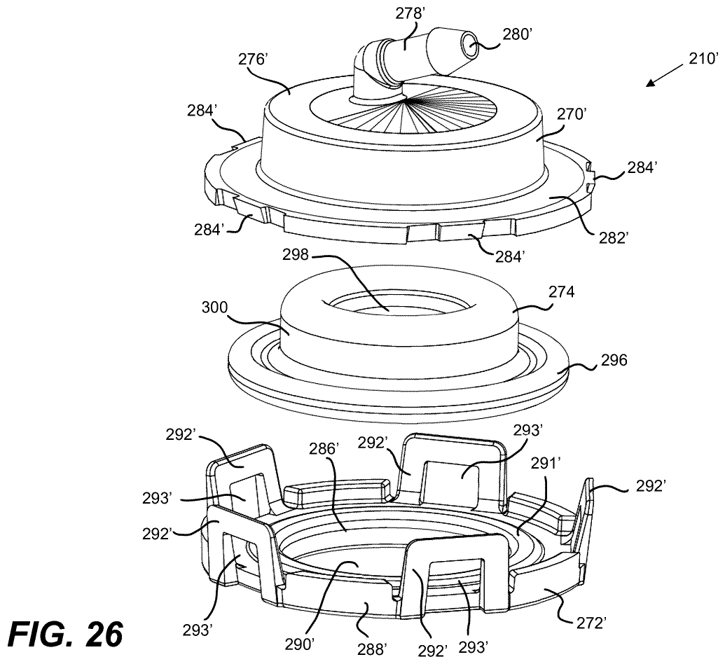

As shown in FIGS. 25 and 26, in this alternative embodiment, the diaphragm 274 is set in an opposite orientation to that described in the previous embodiment. Notably, in this embodiment, the central portion 298 is disposed vertically higher than the outer peripheral portion 296. Thus, the inner chamber 303 of the valve module 210′ is defined in part by an opposite side of the central portion 298 than in the previously described embodiment. This orientation of the diaphragm 274 may minimize stresses generated along the central portion 298 after repeated deformations and thus improve durability.

The diaphragm 274 is fixed between the upper and lower members 270′, 272′ by positioning its central portion 298 into the central aperture 290′ of the lower member 272′ such that the outer peripheral portion 296′ sits on the lower member 272′. The upper member 270′ is then engaged with the lower member 272′ as mentioned above via the detents 292′ and tongues 284′. Once the upper member 270′ is engaged with the lower member 272′, the diaphragm 274 is fixed therebetween and forms, together with the upper member 270′, the inner chamber 303 of the valve module 210′. The inner chamber 303 is accessible via the pilot port 280″. As can be seen in FIG. 25, part of the diaphragm 274 is compressed between the annular ridge 291′ of the lower member 272′ and a lower annular ridge 285′ of the upper member 270′. Moreover, the outer peripheral portion 296 of the diaphragm 274 is compressed and provides a seal for the inner chamber 303 of the valve module 210′.

The inlet valve 176ᵢ, the interconnection valve 178ᵢ and the control valve 179₁ have a similar configuration to the manifold valves 172₁-172₉, notably each having the same valve module 210 or 210′. However, the valves 176ᵢ, 178ᵢ, 179; do not have connectors 223 in this embodiment. Rather, as shown in FIG. 16, the main body 190 has three annular protrusions 217 extending upwardly from the bottom wall 216 in the secondary valve chamber 214, each annular protrusion 217 defining a corresponding valve opening 221. The valve opening 221 defined by each annular protrusion 217 is selectively blocked by the diaphragm 274 of the corresponding valve module 210 as described above with respect to the manifold valves 172₁-172₉. The valve opening 221 defined by each annular protrusion 217 has greater dimensions than the opening 245 of each connector 223 which may allow a greater air flow rate to flow through the valves 176₁, 178₁, 179₁. For instance, an air flow rate through the valves 176₁, 178₁, 179₁ may be at least 50% greater than the air flow rate through the manifold valves 172₁-172₉. In this example, the air flow rate through the valves 176ᵢ, 178ᵢ, 179ᵢ is approximately 100% greater than the air flow rate through the manifold valves 172₁-172₉.

Although the manifolds 170₁, 170₂ are identical to each other in this embodiment, which may be beneficial for simplifying manufacturing of the pneumatic control assembly 150, it is contemplated that the manifolds 170₁, 170₂ could be configured differently from each other in other embodiments.

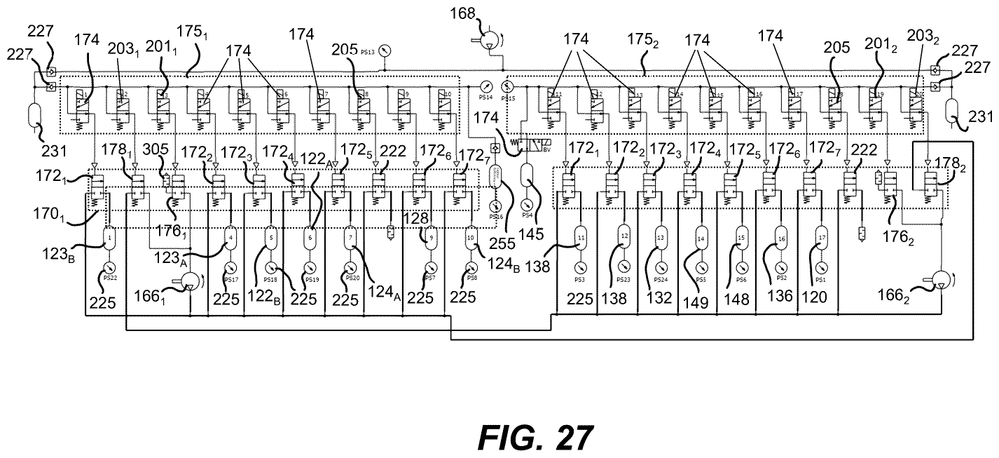

The pneumatic system of the pneumatic control assembly 150 may be configured differently in other embodiments. For instance, certain components (e.g., one or more inflatable sections of the mattress 100) of the pneumatic system may be omitted and/or additional components may be provided. As an example, the pneumatic diagram of an alternative embodiment of the pneumatic system is illustrated in FIG. 27. In this embodiment, the compressor 168 cannot itself feed air to the various inflatable parts of the mattress 100 since the above-described fluid lines 187₁, 187₂ are omitted such that the compressor feed mode described above cannot be implemented. Rather, it is one or both blowers 166₁, 166₂ that drive air into or pull air from the air-powered parts of the mattress 100 in the manner already described above. Similarly, some of the diaphragm valves (and their associated solenoid valves) described in the previous embodiment are omitted to reduce redundancy. For instance, in this embodiment, the purge valve 220 and the control valves 179₁, 179₂ are omitted. Furthermore, in this embodiment, the foot support section 144 of the mattress 100 is omitted and thus the associated valves are also omitted.

With continued reference to FIG. 27, the diaphragm valves are also distributed differently in this embodiment. For instance, each manifold 170₁, 170₂ includes a respective microclimate management valve 222 (fluidly connected to the microclimate management layer 200) that is piloted by a respective solenoid valve 205. The microclimate management valves 222 can be used for exhausting air from the mattress 100. It is to be noted, that some of the inflatable sections of the mattress 100 may be pressurized by air flow directed thereto by a solenoid valve, such as for example the dorsal push bladder 145 as shown in FIG. 27. Furthermore, in this embodiment, two reservoirs 231 are fluidly connected to the compressor 168 so as to be filled thereby. The reservoirs 231 are in turn fluidly connected to the various solenoid valves of the subsets 175₁, 175₂. The reservoirs 231 are provided to compensate for micro air leaks that may occur in the pneumatic system, particularly in situations in which the mattress 100 is not electrically connected to an external power source (e.g., an AC circuit). This may help hold the pressurization of the various bladders of the mattress 100 when the bed 300 is being moved around a hospital for example. In addition, the reservoirs 231 may minimize the number of times the compressor 168 has to be turned on and off to selectively open the diaphragm valves of the manifolds 170₁, 170₂ which can be helpful to limit the noise produced by operation of the pneumatic control assembly 150. Check valves 227 are provided to ensure unidirectional flow of air in parts of the pneumatic system and to function as a fail-safe in case of failure of the solenoid valves that might otherwise cause depressurization of the bladders of the mattress 100. Lastly, in this embodiment, the mattress 100 includes a bottoming-out bladder 255 that is closed and is disposed underneath one or more of the inflatable bladders of the mattress 100. The pressure of the bottoming-out bladder 255 is communicated to the controller 180 which can determine, based on the pressure readings acquired from the bottoming-out bladder 255, whether the patient on the mattress 100 is close to being in a “bottoming-out” position whereby the patient is too deeply immersed in the mattress 100 and is thus close to a rigid surface of the mattress 100. This may allow the controller 180 to adjust the pressure in the inflatable sections of the mattress 100 to counteract the bottoming-out position. The pneumatic system shown in FIG. 27 otherwise functions in the same manner as described in the previous embodiment and therefore will not be described again herein.

It is contemplated that some of the components of the pneumatic control assembly 150 may be omitted in some embodiments. For instance, in some embodiments, the controller 180 could be disposed externally of the pneumatic control assembly 150, integrated as part of the bed 300 or within a separate control unit that is supported by the bed 300 (e.g., at a foot end of the bed 300). In such cases, appropriate connectors are provided to connect the pneumatic control assembly 150 to the external controller.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A pneumatic control assembly for a patient support surface, comprising:
a first air supply device providing air at a high flow rate and a low pressure;
a second air supply device providing air at a low flow rate and a high pressure; and
at least one first valve configured to be fluidly connected to at least one inflatable section of the patient support surface, the at least one first valve being selectively actuated to fluidly connect the first air supply device with a corresponding one of the at least one inflatable section, the at least one first valve being piloted by the second air supply device.

2. The pneumatic control assembly of claim 1, wherein:
the first air supply device provides air at a first flow rate and a first pressure;
the second air supply device provides air at a second flow rate and a second pressure;
the first flow rate is greater than the second flow rate; and
the second pressure is greater than the first pressure.

3. The pneumatic control assembly of claim 1, wherein the first air supply device is a blower and the second air supply device is a compressor.

4. The pneumatic control assembly of claim 1, wherein the first air supply device has a pressure capacity that is less than 15 kPa.

5. The pneumatic control assembly of claim 1, wherein the second air supply device has a pressure capacity that is more than 50 kPa.

6. The pneumatic control assembly of claim 1, wherein:
each of the at least one first valve has a pilot port;
the pneumatic control assembly further comprises at least one solenoid valve, the at least one solenoid valve being fluidly connected to the second air supply device and to the pilot port of the at least one first valve; and
the at least one solenoid valve is selectively actuated to control air flow from the second air supply device to the pilot port of the at least one first valve to thereby actuate the at least one first valve.

7. The pneumatic control assembly of claim 6, wherein each of the at least one first valve is a diaphragm valve.

8. The pneumatic control assembly of claim 7, wherein each diaphragm valve includes a diaphragm that is selectively deformable from a first position to a second position in response to the pilot port being in fluid communication with the second air supply device.

9. The pneumatic control assembly of claim 7, further comprising a manifold comprising the at least one first valve, the manifold being in fluid communication with the first air supply device.

10. The pneumatic control assembly of claim 1, wherein:
the at least one inflatable section is at least one first inflatable section;
the first air supply device is in selective fluid communication with the at least one first inflatable section via at least one first valve;
the pneumatic control assembly further comprises:
a third air supply device providing air at the high flow rate and the low pressure; and
at least one second valve configured to be fluidly connected to at least one second inflatable section of the patient support surface, the at least one second valve being selectively actuated to fluidly connect the third air supply device with the at least one second inflatable section, the at least one second valve being piloted by the second air supply device.

11. The pneumatic control assembly of claim 10, wherein the third air supply device is a blower.

12. The pneumatic control assembly of claim 1, further comprising:
a reservoir that is fluidly connected to the second air supply device,
the reservoir being filled by the second air supply device to contain pressurized air therein,
the at least one first valve being selectively piloted by the reservoir.

13. The pneumatic control assembly of claim 1, further comprising a housing enclosing the first air supply device, the second air supply device and the at least one first valve.

14. A patient support surface for a patient support apparatus comprising:
a plurality of inflatable sections;
the pneumatic control assembly of claim 1 for controlling air flow to the inflatable sections; and
a cover enclosing the inflatable sections and the pneumatic control assembly.

15. The patient support surface of claim 14, wherein the pneumatic control assembly is located near a foot end of the patient support surface.

16. The patient support surface of claim 15, wherein the inflatable sections include an inflatable foot section, the pneumatic control assembly being disposed underneath the inflatable foot section.
